(19) United States
(12) Patent Application Publication
(10) Pub. No.: US 2026/0359638 A1
(43) Pub. Date: Nov. 12, 2026

(54) Systems and Methods for Joint Fine-Tuning and Compression of Neural Networks

(71) Applicant: Mitsubishi Electric Research Laboratories, Inc., Cambridge, MA (US)

(72) Inventors: Toshiaki Koike-Akino, Cambridge, MA (US); Xiangyu Chen, Lawlence, KS (US); Jing Liu, Santa Clara, CA (US); Ye Wang, Cambridge, MA (US)

(73) Assignee: Mitsubishi Electric Research Laboratories, Inc., Cambridge, MA (US)

(21) Appl. No.: 19/302,548

(22) Filed: Aug. 18, 2025

Related U.S. Application Data
(60) Provisional application No. 63/802,213, filed on May 8, 2025.

(51) Int. Cl. G06N 3/082; G06N 3/0495

(52) U.S. Cl. CPC G06N 3/082; G06N 3/0495

(57) ABSTRACT

A method and system are provided for constructing neural network models optimized for reduced computational resource usage. A weight matrix of a neural network layer is represented as a parameterized, compressible data structure comprising learnable parameters. A composite objective function is determined, including a task loss component measuring predictive performance and a compression loss component penalizing resource usage characteristics such as parameter dimensionality, sparsity, or numerical precision, for the neural network model. The neural network model is iteratively optimized with respect to the composite objective function using gradient-based updates to the compressible structure. The resulting model achieves both accuracy and efficiency objectives during a shared optimization process. The optimized compressible data structure may be adapted for different target tasks, enabling task-specific architectures with reduced inference cost. The trained neural network model is deployable in various environments without reliance on fixed, pretrained components used during optimization.

### TECHNICAL FIELD

The present disclosure relates generally to the field of artificial intelligence and machine learning, and more specifically to systems and methods for compressing neural network models. In particular, the disclosure pertains to techniques for integrating fine-tuning and compression operations for the neural network models.

### BACKGROUND

Artificial intelligence (AI) systems, particularly those based on deep neural networks (DNNs) and large-scale transformer architectures such as large vision-language models (LVLMs), have demonstrated state-of-the-art performance across a wide range of tasks, including vision, language, and multi-modal understanding. However, such performance often comes at the cost of significant computational, memory, and energy demands. These large models may consist of millions, billions or even trillions of parameters, making them difficult to store, transmit, or execute efficiently in constrained systems and environments.

To mitigate these challenges, various approaches have been developed to reduce the size and complexity of neural network models. These include structural simplification techniques such as pruning, which removes less important connections; quantization, which reduces numerical precision; and low-rank approximation, which reduces the intrinsic dimensionality of weight matrices. Such methods are commonly referred to as model compression techniques, and their use has become widespread in domains where computational efficiency is critical.

Despite their utility, these techniques are frequently implemented in a way that is procedurally or operationally separate from other model development activities. Compression is often treated as a standalone transformation, applied to existing models through a distinct sequence of steps and optimization criteria. This separation reflects longstanding assumptions about how models are prepared for deployment, and how efficiency objectives are managed in relation to other performance goals.

In many cases, the compression process relies on manually defined heuristics or fixed schedules, such as predetermined pruning ratios, quantization levels, or dimensionality thresholds. These static configurations may not fully reflect the model's operational context or intended use case, and can lead to unnecessary degradation in functional performance, or require iterative adjustments to achieve acceptable tradeoffs.

Given the increasing demand for deploying models in environments with strict efficiency constraints—such as embedded processors, mobile platforms, and distributed edge networks—there is a need for approaches that overcome the limitations of the approaches described above.

### SUMMARY

Some embodiments provide methods and systems to overcome the challenges of the approaches described above and to allow model compression to become more adaptive, integrated, and context-sensitive, rather than being performed as a dedicated, external, or disconnected procedure.

Some embodiments are based on a recognition that many limitations in existing model compression practices stem from a procedural assumption: that compression must occur after a model has already been constructed and optimized. This assumption has led to a rigid separation between the development of a performant model and its adaptation to meet resource constraints. As a result, this separation introduces inefficiencies, limits adaptability, and often forces developers into reactive strategies for achieving efficiency.

To that end, some embodiments are based on a recognition that model compression operations, such as pruning, low-rank approximation, and parameter quantization, may be integrated into the training process of neural networks in a differentiable and jointly optimized manner, thereby enabling efficient adaptation of large-scale models to resource-constrained deployment environments.

However, sequentially fine-tuning and compression sacrifices performance due to not leveraging the power of fine-tuning to compensate for the performance loss introduced in the subsequent compression steps.

Some embodiments are based on a recognition that this separation is not a technical necessity, but rather a byproduct of historical tooling and design workflows. Compression has typically been implemented as a standalone transformation process with its own heuristics and metrics, disconnected from the broader model optimization flow. This disconnect means compression decisions are made without real-time insight into task performance, leading to imprecise tradeoffs between model compactness and accuracy.

Some embodiments are also based on the recognition that compression is often conceptualized as a static transformation rather than a tunable and responsive operation. By reevaluating this conceptual boundary, it becomes apparent that model compression can be formulated as a learnable process, capable of integration into modern optimization pipelines.

Specifically, it was recognized that many standard compression operations—such as pruning, dimensionality reduction, and structural decomposition—can be expressed as parameterized modules within a model architecture. These modules may contain internal variables that are adjustable through gradient-based optimization techniques or other heuristic optimization techniques, thus allowing compression behavior to be shaped by the same dynamics that guide model learning more broadly.

Further, some embodiments are based on a recognition that compression decisions need not be binary or discrete in nature. Continuous formulations, such as soft-thresholding, differentiable masking, or weighted approximations, allow compression to be tuned in a smooth and data-dependent manner. This continuous representation makes it possible to align compression goals and task objectives within the same optimization loop.

Some embodiments also leverage the recognition that compression strategies can benefit from task-specific feedback. The compressibility of certain model components may vary depending on their relevance to the target function. Embedding compression logic within a dynamic optimization framework allows the system to identify and exploit such differences to achieve more efficient model architectures.

Additionally, some embodiments are based on a recognition that resource reduction goals—such as minimizing parameter count, memory usage, or computation—can be expressed directly as optimization terms alongside standard loss functions. This enables co-optimization of both performance and efficiency objectives, allowing models to converge toward solutions that are both accurate and compact.

Based on these recognitions, some embodiments establish a new paradigm in which model compression is not treated as an auxiliary or post hoc procedure, but rather as an integral component of model construction and refinement. This conceptual shift enables the design of systems that are inherently resource-aware and deployable without the need for separate compression stages or manual intervention.

Some embodiments are based on the realization that a pretrained AI model is progressively compressed along with the low-rank finetuning for a downstream task. For example, the progressive compression is based on scheduling of masking weights for pretrained weight eigenvectors and low-rank adaptors. Some embodiments accelerate the joint compression and finetuning by incorporating a rank initialization according to the input feature statistics via pre-conditioning matrix. Some embodiments are based on the progressive scheduling of distillation loss to control how much deviation from the pretrained AI behavior is allowed over finetuning iterations. The progressive scheduling includes the adaptation of the rank of pretrained weights and adaptor weights over the finetuning loops. For example, the rank of adapters is gradually decreased or increased over finetuning, and the rank of pretrained weights are gradually decreased to decay out the impact of the original weights. Yet another embodiment uses iterative rounding and thresholding over finetuning for progressive change of numerical precision and parameter sparsity. For example, once per few finetuning iterations, a rounding projection is performed at a gradually decreasing quantization level. It can provide the benefit of quantization-aware finetuning and smooth optimization towards more compact and more accurate AI models. Iterative thresholding in the loop of finetuning iterations can also significantly reduce the parameter counts and memory size, while the progressive scheduling of the threshold can keep high accuracy. The iterative thresholding includes soft thresholding projection, hard thresholding projection, and a variant thereof. Some embodiments use low-rank projection in a loop of finetuning, where pretrained weights and adapters weights are merged and then re-decomposed into low-rank pretrained weights and adapters for further finetuning. Yet another embodiment uses a trainable hyperparameter for the progressive scheduling. For example, the power decay factor for individual eigenvectors is trained across the finetuning operations.

To reduce the computational resource of AI systems, a pre-trained large AI model is converted into a small AI model through a transformation based on a joint model compression and adaptation. The methods and systems disclosed herein in various embodiments provide an improvement in the AI accuracy by gradually reducing the model size during the fine-tuning steps. This progressive model compression utilizes new techniques involving dynamic power scaling, rank weighting, distillation regularization, iterative thresholding, and quantization. In addition, the input/output feature statistics are compensated by proper pre-conditioning matrix. Using a control of junction matrices, the computational demands are further reduced by formulating into a block identity format.

Accordingly, some embodiments disclose a computer-implemented method for constructing a neural network model. The computer-implemented method includes generating a compressible data structure for at least one weight matrix of a layer of the neural network model. The compressible data structure includes one or more learnable parameters subject to adjustment during optimization. The computer-implemented method further includes determining a composite objective function associated with the neural network model. The composite objective function includes a task loss component configured to evaluate predictive performance of the neural network model with respect to a target task, and a compression loss component configured to penalize resource usage characteristics of the neural network model. The resource usage characteristics of the neural network model include one or more of: parameter dimensionality, parameter sparsity, or numerical precision. The computer-implemented further includes iteratively optimizing the neural network model with respect to the composite objective function until a termination condition is met, the iterative optimization comprising performing gradient-based optimization to the one or more learnable parameters of the compressible data structure. Additionally, the method includes outputting the optimized neural network model comprising the optimized compressible data structure.

According to some embodiments, a system for constructing a neural network model is provided. The system is configured for reduced computational resource usage. The system includes one or more processors and a memory for storing instructions that, when executed by the one or more processors, cause the system to generate a compressible data structure for at least one weight matrix of a layer of the neural network model. The compressible data structure includes one or more learnable parameters subject to adjustment during optimization. The system is also caused to determine a composite objective function associated with the neural network model. The composite objective function includes a task loss component configured to evaluate predictive performance of the neural network model with respect to a target task. The composite objective function also includes a compression loss component configured to penalize resource usage characteristics of the neural network model, the resource usage characteristics including one or more of: parameter dimensionality, parameter sparsity, or numerical precision. The system is also caused to iteratively optimize the neural network model with respect to the composite objective function until a termination condition is met, the iterative optimization comprising performing gradient-based optimization to the one or more learnable parameters of the compressible data structure. Further, the system is caused to output the optimized neural network model comprising the optimized compressible data structure.

Further features and advantages will become more readily apparent from the following detailed description when taken in conjunction with the accompanying drawings.

### BRIEF DESCRIPTION OF THE DRAWINGS

FIG. 1 illustrates a block diagram of a workflow evolution for generation of a neural network model, according to some embodiments of the present disclosure.

FIG. 2A illustrates a flowchart of a method implementing the joint fine-tuning and compression process for generating a neural network model, according to an embodiment of the present disclosure.

FIG. 2B illustrates a block diagram of a system implementing the joint fine-tuning and compression process for generating a neural network model, according to an embodiment of the present disclosure.

FIG. 3 illustrates a schematic diagram showing generation of a compressible data structure, according to an embodiment of the present disclosure.

FIG. 4 illustrates a schematic diagram showing a composite objective function, according to an embodiment of the present disclosure.

FIG. 5A illustrates a schematic diagram showing an iterative optimization process, according to an embodiment of the present disclosure.

FIG. 5B illustrates a flowchart of a method showing an example implementation of the iterative optimization process shown in FIG. 5A., according to an embodiment of the present disclosure.

FIG. 6 illustrates a graphical plot showing influence of the decay function at on the performance of the neural network model, according to an embodiment of the present disclosure.

FIG. 7 illustrates a graphical plot showing an example of the decaying of layer-wise regularization factor, according to an embodiment of the present disclosure.

FIG. 8 is a schematic diagram illustrating an example of initialization of the low-rank matrices A and B based on original weight matrix, W and a precondition matrix, according to an embodiment of the present disclosure.

FIG. 9 illustrates a schematic diagram illustrating an example of disclosed compressed representations where the ranks of the low-rank matrices are adaptive/nonuniform for different components, for the neural network model, according to an embodiment of the present disclosure.

FIG. 10 illustrates a schematic diagram showing example operations performed on the input X, using the joint fine-tuning and compression process performed by the neural network model, according to an embodiment of the present disclosure.

FIG. 11 illustrates schematic diagram of a joint fine-tuning and compression as well as quantization operation, according to an embodiment of the present disclosure.

FIG. 12 illustrates a schematic diagram of joint fine-tuning and compression operation followed by pruning, according to an embodiment of the present disclosure.

FIG. 13 illustrates a schematic diagram of simultaneous joint fine-tuning and compression operation followed by pruning, according to an embodiment of the present disclosure.

FIG. 14 illustrates a schematic diagram of joint fine-tuning and compression operation followed by quantization, according to an embodiment of the present disclosure.

FIG. 15 illustrates a schematic diagram of joint fine-tuning and compression operation followed by pruning and quantization, according to an embodiment of the present disclosure.

FIG. 16 illustrates a schematic diagram of joint fine-tuning and compression operation followed by joint pruning and quantization, according to an embodiment of the present disclosure.

FIG. 17 illustrates a schematic diagram of joint fine-tuning and compression and pruning, according to an embodiment of the present disclosure.

FIG. 18 illustrates a schematic diagram of joint fine-tuning and compression and quantization, according to an embodiment of the present disclosure.

FIG. 19 illustrates a schematic diagram of joint fine-tuning and compression and pruning and quantization, according to an embodiment of the present disclosure.

FIG. 20 illustrates a schematic diagram of an exemplary optimization framework for fine-tuning neural network weights for neural network model, according to an embodiment of the present disclosure.

FIG. 21 illustrates a schematic diagram showing an example implementation of the joint fine-tuning and optimization process for the neural network model, showing training and inference phases side-by-side, according to an embodiment of the present disclosure.

FIG. 22 illustrates a schematic diagram showing plurality of layers of the neural network model and their corresponding compressible data structures, according to an embodiment of the present disclosure.

FIG. 23 illustrates a schematic diagram showing a pipeline of task performance by the neural network model, according to an embodiment of the present disclosure.

FIG. 24 is a schematic diagram illustrating different compressible data structures associated with different tasks, according to an embodiment of the present disclosure.

FIG. 25A and FIG. 25B jointly illustrate the performance characteristics of the neural network model trained by the joint fine-tuning and optimization process, in comparison with other model tuning and model compression technologies, according to an embodiment of the present disclosure.

FIG. 25C illustrates a table showing a comparison of initialization methods for the low-rank matrices used in the compressible data structure, according to an embodiment of the present disclosure.

FIG. 25D illustrates a table showing a comparison of regularization decay strategy of the joint fine-tuning and compression process with the constant regularization, according to an embodiment of the present disclosure.

FIG. 26 illustrates a block diagram of a computing device that is representative of any system or collection of systems in which the various processes, programs, services, and scenarios disclosed herein may be implemented, according to an embodiment of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Neural network models such as large transformer-based models have demonstrated superior performance in many tasks, including natural language processing and computer vision. However, their enormous size requires substantial computational power and memory for fine-tuning and deployment to effectively adapt to downstream tasks. To tackle these, Parameter-Efficient Fine-Tuning (PEFT) was widely explored to reduce memory consumption in fine-tuning. In deployment, various post-training compression techniques have been employed in these fine-tuned models, including weight quantization, knowledge distillation, and network pruning. However, sequentially fine-tuning and compression often suffers from significant performance loss.

Some embodiments are based on the realization that a pretrained AI model is progressively compressed along with the low-rank finetuning for a downstream task. For example, the progressive compression is based on scheduling of masking weights for pretrained weight eigenvectors and low-rank adaptors. Some embodiments use multiple individual decaying function for the masking weight scheduling across different eigenvectors of pretrained weight matrix. The eigenvectors of the pretrained weight matrix are first initialized with singular value decomposition or other high-order tensor rank decomposition along with a pre-conditioning matrix. The pre-conditioning matrix is obtained by moments of activation features such as covariance, mean, Hessian matrix, and so on. Some embodiments use re-initialization with a tensor rank decomposition in the loop of iterative finetuning.

Some embodiments accelerate the joint compression and finetuning by incorporating a rank initialization according to the input feature statistics via pre-conditioning matrix. Some embodiments are based on the progressive scheduling of distillation loss to control how much deviation from the pretrained AI behavior is allowed over finetuning iterations. The progressive scheduling includes the adaptation of the rank of pretrained weights and adaptor weights over the finetuning loops. For example, the rank of adapters is gradually decreased or increased over finetuning, and the rank of pretrained weights are gradually decreased to decay out the impact of the original weights. Yet another embodiment uses iterative rounding and thresholding over finetuning for progressive change of numerical precision and parameter sparsity. For example, once per a few finetuning iterations, rounding projection is performed at a gradually decreasing quantization level. It can provide the benefit of quantization-aware finetuning and smooth optimization towards more compact and more accurate AI models. Iterative thresholding in the loop of finetuning iterations can also significantly reduce the parameter counts and memory size while the progressive scheduling of the threshold can keep high accuracy. Yet another embodiment uses a trainable hyperparameter for the progressive scheduling. For example, the power decay factor for individual eigenvectors is trained across the finetuning operations.

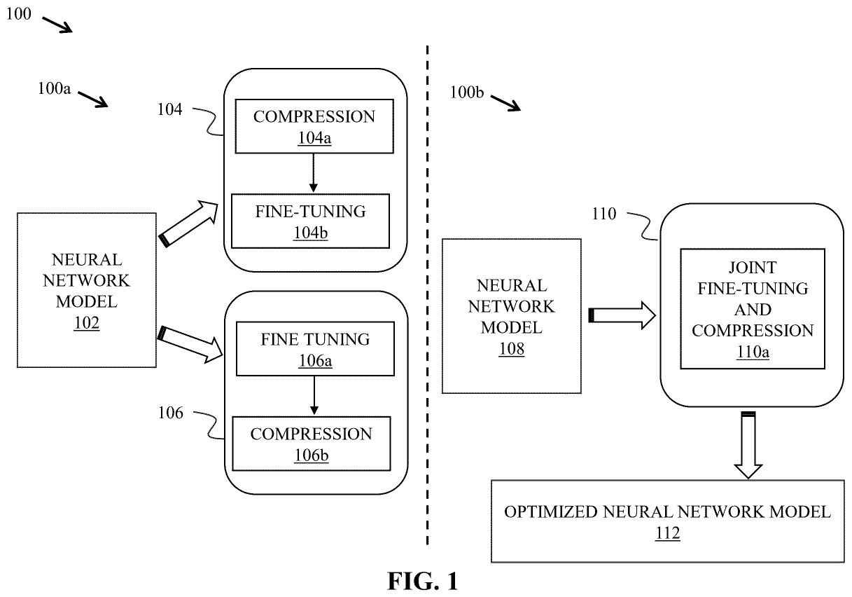

FIG. 1 illustrates a schematic diagram 100 of a workflow evolution for generation of a neural network model, according to some embodiments of the present disclosure.

The schematic diagram 100 includes two processing pipelines for constructing and optimizing neural network models. At the left side is a first processing pipeline 100a which uses sequential compression and fine-tuning methods. A method 104 shows that a neural network model 102 may be subjected to a sequence of operations including compression 104a followed by fine-tuning 104b, whereas a module 106 shows a sequence of operations including fine-tuning 106a followed by compression 106b. The processing pipeline 100a represents traditional two-stage workflows in which compression and fine-tuning are decoupled and applied in series. Such sequential approaches may lead to suboptimal performance, as they fail to jointly consider the trade-offs between compression efficacy and task-specific accuracy during training. Also, such sequential fine-tuning and compression pipelines sacrifice performance due to not leveraging the power of fine-tuning to compensate for the performance loss introduced in the subsequent compression steps.

To overcome these deficiencies, the present disclosure includes methods and systems to implement a second processing pipeline 100a which is based on a recognition that neural network model compression need not be implemented as a standalone transformation process with its own heuristics and metrics, disconnected from the broader model optimization flow. The second processing pipeline 100b is further based on the recognition that model compression can be formulated as a learnable process, capable of integration into modern optimization pipelines.

To that end, the second processing pipeline 100b includes a neural network model 108 that is subjected to a method 110 of joint fine-tuning and compression to produce an optimized neural network model 112. The method 110 includes performing a joint fine-tuning and compression process 110a which is a co-optimization process in which learnable parameters of a compressible data structure may be updated simultaneously with respect to both a task loss (reflecting model accuracy) and a compression loss (reflecting resource usage constraints such as sparsity, dimensionality, or numerical precision). This joint optimization strategy enables more efficient compression without significant degradation in predictive performance and eliminates the need for separate compression and retraining stages.

Thus, the second processing pipeline 100b is based on an architecture of joint fine-tuning and compression process 110a, which unlike the sequential processing of the first processing pipeline 100a enables end-to-end training of compressible neural network representations in a resource-aware and task-adaptive manner. Accordingly, the present disclosure enables a more efficient deployment of neural network models, particularly in environments with constrained memory, compute, or bandwidth resources.

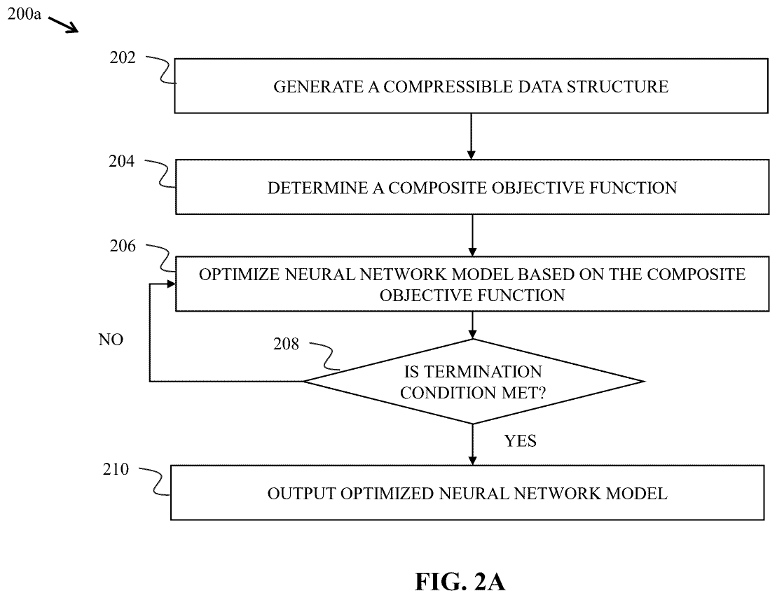

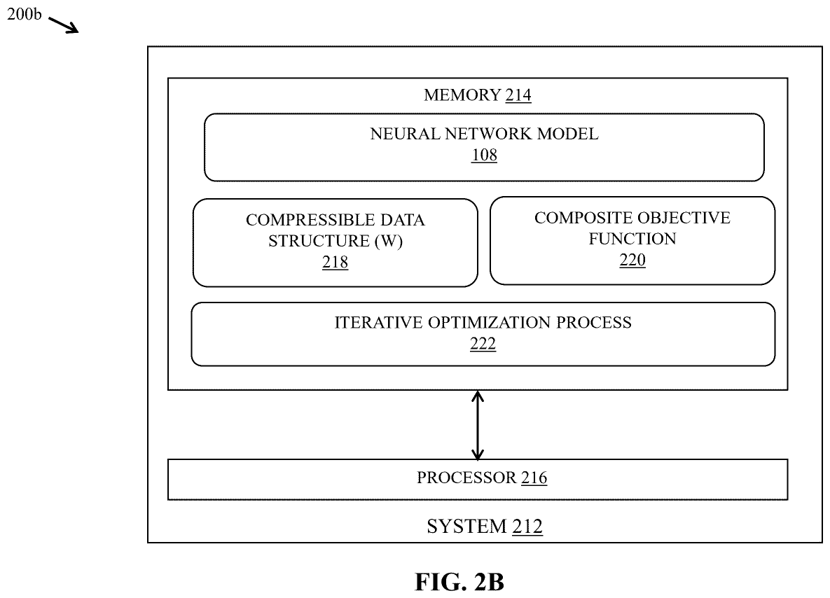

FIG. 2A illustrates flowchart of a method 200a for implementing the joint fine-tuning and compression process 110a for generating a neural network model which is optimized by an end-to-end training of compressible neural network representations in a resource-aware and task-adaptive manner, according to an embodiment of the present disclosure. FIG. 2A is explained in conjunction with FIG. 1. The method 200a may be executed by the neural network model 108, which may include computing hardware such as memory and one or more processors to execute the method 200a.

In some embodiments, the method 200a is implemented by a computer, such as specialized hardware, software, or firmware that may include one or more processors for executing computer executable instructions embodying the functionality of various operations disclosed in the method 200a. The computer-executable instructions may be stored in a non-transitory computer-readable storage medium.

The method 200a is used for constructing a neural network model, such as the neural network model 108 illustrated in FIG. 1. The method 200a highlights the end-to-end process of the neural network model construction wherein the compression of network parameters is integrated into the training loop itself, enabling the production of a resource-efficient neural network model without post hoc compression or separate fine-tuning stages.

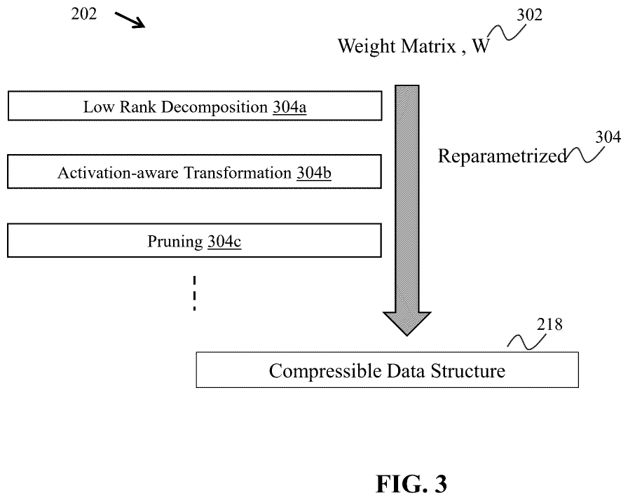

The method 200a includes, at operation 202, generating a compressible data structure. The compressible data structure is generated for at least one weight matrix of a layer of the neural network model 108. In some embodiments, the weight matrix of the neural network model 108 is represented as the compressible data structure. As may be understood by one of ordinary skill in the art, the neural network model 108 may include a plurality of layers. In some embodiments, each layer of these plurality of layers may be a linear layer. Thus, each linear layer may be associated with a weight matrix, which is represented as the compressible data structure. The compressible data structure comprises one or more learnable parameters that may be subject to adjustment during optimization. In some embodiments, the learnable parameters may be dependent on the underlying downstream task to be performed by the neural network model 108. Generation of the compressible data structure is further illustrated in FIG. 3.

The method 200a further includes, at operation 204, determining a composite objective function associated with the neural network model 108. In some embodiments, the composite objective function includes a task loss component and a compression loss component. The task loss component is configured to evaluate predictive performance of the neural network model 108 with respect to a target task. The compression loss component is configured to penalize resource usage characteristics of the neural network model 108. The resource usage characteristics of the neural network model 108 may include one or more of—parameter dimensionality, parameter sparsity, or numerical precision.

As used herein, parameter dimensionality refers to the total number of learnable parameters or elements within the weight matrices or tensors of the neural network model 108, which directly impacts the neural network models' 108 memory footprint and computational complexity. Parameter sparsity denotes the proportion of zero-valued or pruned parameters in a given weight matrix or neural network layer and serves as a measure of structural efficiency that can be exploited to reduce both memory usage and the number of required arithmetic operations during inference. Numerical precision pertains to the bit-width or resolution used to represent parameter values (e.g., 32-bit floating point, 8-bit integer, or binary), with lower-precision formats enabling faster computations and reduced storage requirements, albeit potentially at the cost of reduced numerical accuracy. Collectively, these characteristics quantify the neural network model's 108 computational and memory efficiency and are therefore targeted by the compression loss component of the composite objective function to ensure that the resulting neural network model 108 is both performant and deployment-friendly.

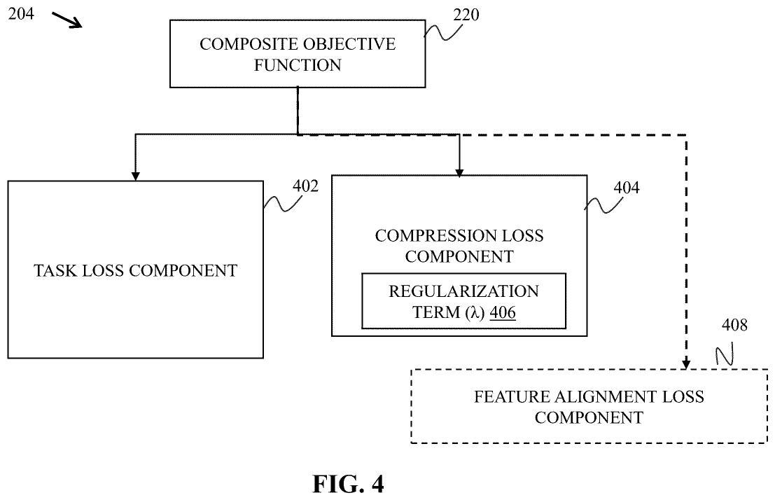

In some embodiments, the composite objective function further includes a feature alignment loss component. The feature alignment loss component is configured to minimize a difference between intermediate representations produced by the compressible data structure and corresponding representations produced by a non-compressed reference structure. To that end, the feature alignment loss component is weighted by a dynamic regularization coefficient that decreases during optimization, such that the influence of the alignment loss diminishes over time. The composite objective function and various components are further elaborated in conjunction with FIG. 4.

The method 200a includes, at operation 206, iteratively optimizing the neural network model with respect to the composite objective function until a termination condition is met. At operation 208, the termination condition is checked. If the termination condition is met, then at operation 210, an optimized neural network model is output. For example, the optimized neural network model 112 may be produced as the output of the iterative optimization operation. However, if the termination condition is not met, then the operation 206 is continues to iteratively optimize the neural network model 108 based on the composite objective function. For example, the termination condition may be defined by convergence of a composite loss defined by the composite objective function, achievement of a target compression ratio, satisfaction of a validation accuracy threshold, or the completion of a predetermined number of training epochs, reaching a maximum number of iterations, achieving a plateau in performance, or satisfying a user-defined convergence criterion and the like.

To that end, the iterative optimization of the neural network model 108 may be performed by a gradient-based optimizer (such as SGD or Adam). The gradient based optimizer is used to update the learnable parameters of the compressible data structure with respect to the composite objective function. This process ensures that both predictive accuracy and resource efficiency are considered simultaneously during training of the neural network model 108.

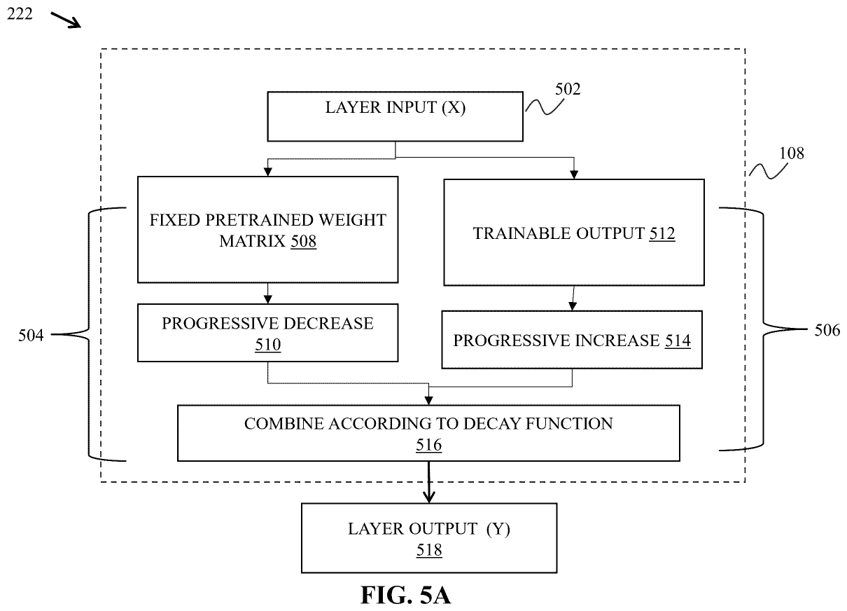

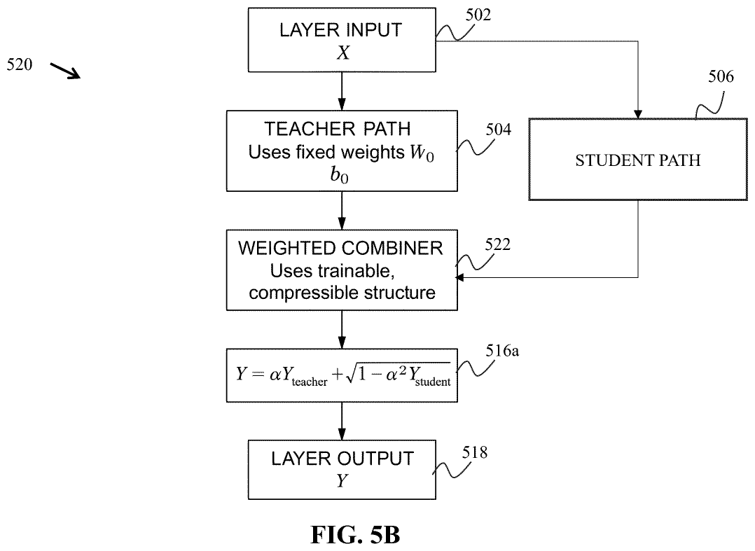

In some embodiments, the iterative optimization comprises performing gradient-based optimization to the one or more learnable parameters of the compressible data structure. Further, the optimized neural network model 112 includes an optimized compressible data structure. Thus, the optimized neural network model includes the learned compressible data structures. The resulting optimized neural network model exhibits reduced memory and compute requirements due to its compressed internal representations, while maintaining acceptable performance on the target task. The iterative optimization is further explained in conjunction with FIG. 5.

The method 200a provides a joint compression and fine-tuning workflow for the neural network model in which compression is integrated directly into the optimization loop of the neural network model as a learnable structure, which is the compressible data structure, enabling joint training. Thus, by executing the method 200a, compression is treated as a differentiable and trainable process, leading to improved efficiency and adaptability of the neural network model 108. By embedding compression into the neural network model's 108 parameterization and optimizing it jointly with task performance, the disclosed method 200a provides a unified framework for constructing neural networks optimized for deployment in resource-constrained environments. The method 200a may be implemented as operations performed by a processor. The processor may be embodied as a system that includes the capabilities to perform the various steps of the method 200a either independently or in connection with other systems. An example of such a system is illustrated in FIG. 2B.

FIG. 2B illustrates an example block diagram 200b of a system 212 for constructing the neural network model 108 configured for reduced computational resource usage, in accordance with an embodiment of the present disclosure. FIG. 2B is explained in conjunction with elements from FIG. 1, and FIG. 2B. The system 212 includes a memory 214 and a processor 216.

In some embodiments, the processor 216 includes one or more processors configured to execute instructions stored in the memory 214 to perform the functionalities of the method 200a described in FIG. 2A. The processor(s) 216 may include a central processing unit (CPU), a graphics processing unit (GPU), a digital signal processor (DSP), a tensor processing unit (TPU), a neural processing unit (NPU), a field-programmable gate array (FPGA), an application-specific integrated circuit (ASIC), or any combination thereof. In some embodiments, the processor 216 is configured to execute operations associated with artificial intelligence models, such as machine learning models like the neural network model 108, vision-language models, including but not limited to model inference, data preprocessing, and post-processing. The processor 216 may also be configured to coordinate communication between system components, manage memory access, and perform control logic and decision-making functions. The processor 216 may be implemented as a single processing unit or distributed across multiple processors operating in parallel or in a networked configuration.

In some embodiments, the memory 214 includes one or more memory devices (e.g., memory, data storage, or computer-readable storage media) configured to store instructions that, when executed by one or more processors, such as the processor 216, cause the system 212 to perform the operations described herein. The memory 214 may include volatile memory (e.g., random-access memory (RAM)) and/or non-volatile memory (e.g., read-only memory (ROM), flash memory, solid-state drives (SSDs), magnetic storage, or other persistent storage). In some embodiments, the memory 214 stores data structures, models, intermediate computations, and program logic, including code implementing one or more artificial intelligence modules, such as machine learning models, the neural network model 108, a vision-language models, and the like. The memory 214 may be implemented as a single device or distributed across multiple physical storage units and may be local to the processing system or remotely accessible over a network. The memory 214 stores at least the neural network model 108, a compressible data structure 218, a composite objective function 220, and an iterative optimization process 222 implemented as a code or computer-program. For example, this is shown in operation 206 and operation 208 of the method 200a.

By virtue of interaction between the various components stored in the memory 214 as described above, the processor 216 is configured to implement the operations of the method 200a. For example, the processor 216 is configured to execute instructions to generate the compressible data structure 218 for at least one weight matrix of a layer of the neural network model 108. For example, this is shown in operation 202 of the method 200a. The compressible data structure 218 includes one or more learnable parameters subject to adjustment during optimization performed in the steps included in the iterative optimization process 222. The processor 216 is also caused to execute instructions to determine the composite objective function 220 associated with the neural network model 108. This is shown in operation 204 of the method 200a. The composite objective function 220 includes a task loss component configured to evaluate predictive performance of the neural network model 108 with respect to a target task. The composite objective function 220 also includes a compression loss component configured to penalize resource usage characteristics of the neural network model 108. The resource usage characteristics include, for example, one or more of: parameter dimensionality, parameter sparsity, or numerical precision. The processor 216 is further configured to iteratively optimize the neural network model 108 with respect to the composite objective function until a termination condition is met. For example, this is shown in operation 206 and operation 208 of the method 200a. The iterative optimization operations include performing gradient-based optimization to the one or more learnable parameters of the compressible data structure. After the iterative optimization is terminated, the processor 216 is caused to output the optimized neural network model 112 comprising the optimized compressible data structure. For example, this is described in operation 210 of the method 200a.

Each of the operations described above in conjunction with FIG. 2A and FIG. 2B are described in further details in the accompanying description and drawings.

FIG. 3 illustrates a schematic diagram showing the operation 202 of the method 200a for generation of the compressible data structure 218, according to an embodiment of the present disclosure. FIG. 3 is explained in conjunction with elements from FIG. 2A and FIG. 2B.

In some embodiments, the compressible data structure 218 is used in the neural network model 108 in lieu of dense weight matrices. To that end, a weight matrix 302, W, of the neural network model 108 is reparametrized 304 into a form that is inherently compressible. As a result of the reparameterization 304, the compressible structure 218 is used in place of the conventional weight matrix 302. Unlike fixed or statically pruned matrices, the compressible data structure 218 is trainable and adaptive.

In various embodiments, the compressible data structure 218 may take various mathematical forms—such as low-rank matrices (e.g., W≈BA), sparse matrices with learnable masks, or quantized representations—that reduce the number of effective parameters during inference stage of the neural network model 108 without compromising accuracy. The components of the compressible data structure 218 are initialized and updated through the same training pipeline as the rest of the neural network model 108.

In some embodiments, the compressible data structure 218 is associated with one or more learnable parameters, which are designed to adapt to a task data. The learnable parameters of the compressible data structure 218 enable dynamic reallocation of model capacity of the neural network model 108, focusing complexity where it benefits task performance and minimizing it where it does not. As a result, the compressible data structure 218 enables compression not as a heuristic post-processing step but as a first-class optimization target within a learning loop of the neural network model 108.

In some embodiments, the reparameterization 304 of the weight matrix 302 includes representing the weight matrix 302 as the compressible data structure 218 by performing a low-rank decomposition 304a of the weight matrix 302. As a result, the original weight matrix 302 may be represented as a product of learnable matrices of reduced dimensionality.

In some embodiments, the low-rank decomposition 304a uses a pair of low-rank matrices A∈ [symbol] ^{r×d}^{ᵢₙ} and B∈ [symbol] ^{d}^{ₒᵤₜ}^{×T} to approximate the compressible data structure 218 as a matrix W∈ [symbol] ^{d}^{ₒᵤₜ}^{×d}^{ᵢₙ}, via W≈BA, where typically the rank r<<min{dⁱⁿ, d^{out}}. Compared to the original weight matrix W, the parameters used for the low-rank decomposition 304a reduces from d² to 2dr when dⁱⁿ=d^{out}=d.

In this embodiment, the weight matrix W that defines the transformation in a neural network layer is approximated by a matrix product W=BA, where B and A are learnable matrices. The matrix B has dimensions m×r, and matrix A has dimensions r×n, where r<<min(m, n). The purpose of introducing this low-rank decomposition is to substantially reduce the number of parameters required to represent the transformation within the layer. Instead of needing mn parameters to store the full matrix W, the system needs only r(m+n) parameters for B and A combined. This parameter reduction enables a lighter model footprint, faster matrix operations, and lower inference-time computational cost, without severely degrading model expressivity, provided that the rank r is chosen appropriately. Importantly, both matrices B and A are learnable during training, meaning that they are optimized jointly with the rest of the network parameters using standard backpropagation techniques.

The low-rank structure thereby becomes an integral part of the compressible data structure 218. A full-rank matrix W∈ [symbol] ^{m×n} requires mn parameters to store and O(mn) operations to compute a matrix-vector product. In contrast, the decomposition into B∈ [symbol] ^{m×r} and A∈ [symbol] ^{r×n} reduces the parameter count to r(m+n) and the computational complexity to O(r(m+n)).

This reduction can be very substantial in practical cases where r is 10-50× smaller than m or n. For example, if m=n=1024 and r=64, the parameter savings are over 90%, and inference computation speeds up by a comparable factor. The figure illustrates these savings both in terms of memory footprint and FLOPs (floating point operations) required per inference, demonstrating the key technical advantage of adopting low-rank factorization within a learnable compressible structure.

However, this approximation becomes less accurate with smaller rank. A natural way to realize the low-rank decomposition 304a is to use the singular value decomposition (SVD), which decomposes a matrix W as W=USV^{T}, where U, V are the left and right singular vectors, respectively, and S is a diagonal matrix of non-negative singular values that are sorted in descending order, by convention. Truncating the SVD to keep only the largest r singular values and corresponding vectors, yields the optimal rank-r approximation of W (in terms of minimum Frobenius norm error),

$$W \approx {U}_{r} {S}_{r} {V}_{r}^{T} ,$$

where Uᵣ and Vᵣ denote the first r columns of U and V, respectively, and Sᵣ is the top-left r×r block of S, corresponding to the largest (most important) singular values. The low-rank decomposition 304a BA can be formed by

$$B = {U}_{r} {S}_{r}^{1 / 2} , A = {S}_{r}^{1 / 2} {V}_{r}^{T} . \qquad ( 1 )$$

In some embodiments, S₋ᵣ denotes the bottom-right r×r block of S, and U₋ᵣ and V₋ᵣ to denote the corresponding last r columns of U and V, respectively.

In some embodiments, the low-rank decomposition 304a of the weight matrix 302 is initialized using an activation-aware transformation 304b. The activation-aware transformation 304b is computed based on a covariance matrix of activation data X∈ [symbol] ^{d}^{ᵢₙ}^{×l} corresponding to one or more layers of the neural network model 108.

In some embodiments, only approximating the pretrained weights does not consider the effect of the activation statistics on the overall performance of the neural network model 108. To that end, in order to derive the compressible data structure 218, the objective is to approximate WX, given a calibration set of l sample activations arranged in the matrix X∈ [symbol] ^{d}^{ᵢₙ}^{×l}. In some embodiments, an invertible transform matrix C is used to adapt the weights to the pattern of activations X. To that end, SVD is performed on WC, as given below:

W=(WC)C⁻¹=SVD(WC)C⁻¹=(USV^{T})C⁻¹ (2)

Keeping only the top r singular values/vectors, the low-rank decomposition 304a is computed as

$$W \approx \hat{W} := ( {U}_{r} {S}_{r} {V}_{r}^{T} ) {C}^{- 1} .$$

An optimal choice, to minimize.

$${‖ \hat{W} X - WX ‖}_{F}^{2} \qquad ( 3 )$$

is to set C equal to the Cholesky decomposition of the covariance matrix XX^{T}. In some embodiments, this choice of C serves to whiten the activations, i.e., C⁻¹X(C⁻¹X)^{T}=I. Similarly, setting C to be the square root (in terms of the singular values) of the covariance, i.e., C=(XX^{T})^{1/2}, also achieves the optimum, referred to herein as RootCorDA, in contrast to CorDA that sets C=(XX^{T}).

In some embodiments, the activation-aware transformation 304b is computed using a matrix formed by adding a scaled identity matrix to the covariance matrix, C=(XX^{T}) of activation data, and raising the result to a tunable exponent, wherein a scaling factor λ is a damping term and β is a parameter selected from a range between 0 and 1. This may be given as:

C=(XX^{T}+λI)^{β} (4)

In the above equation (4), the tunable exponent β is a hyperparameter such that β∈[0,1] and scaling factor λ is used for damping such that λ≥0 is used to ensure invertibility and improve numerical stability. In some embodiments,

$$β = \frac{1}{2}$$

corresponding to the root-covariance choice.

In some embodiments, to further compress the low-rank structure of the compressible data structure 218, threshold-based pruning 304c is applied to the low-rank matrices. Specifically, the elements with smallest absolute value are zeroed out, in order to achieve a desired compression ratio ρ. This is denoted by: W≈prune(B)prune(A). In some embodiments, the pruning is done via hard shrinkage. That is, given a target pruning ratio ρ, in the forward process of each iteration of the method 200a, the corresponding pruning threshold is dynamically calculated for each low-rank matrix, and elements with magnitudes smaller than the threshold are zeroed out. For example, for the low-rank matrix A, prune(A)=HardShrink (A, ρ), where the HardShrink function sets the smallest ρ percent of the elements in A (in terms of the magnitude) to zero. At the end of the joint fine-tuning and compression process 110a iterations, the original weight matrix W is approximated/replaced by the product of two pruned low-rank matrices, i.e., prune(B)prune(A).

In some embodiments, the number of decomposition matrix is not two. For example, 3 tensor decompositions may be used, single tensor is also an alternative, and the like.

In some embodiments, the compressible data structure 218 is subject to a sparsity-inducing function comprising a differentiable masking or soft-thresholding operation applied to selected weights. In certain embodiments, the compressible data structure is subject to a sparsity-inducing function configured to encourage or enforce sparse parameterization of one or more weight matrices within the neural network model. The sparsity-inducing function may include a differentiable masking operation or a soft-thresholding mechanism, which is applied to selected weights during optimization. Unlike hard pruning, which removes weights in a non-differentiable, discrete manner, the differentiable approach enables the sparsity pattern to be learned as part of the optimization process using gradient-based methods. For example, in one embodiment, weights in the low-rank decomposition 304a (e.g., W≈BA) may be passed through a soft-thresholding function which applies a smooth, differentiable transformation designed to zero out or attenuate low-magnitude weights while preserving gradients. This formulation smoothly pushes smaller weights toward zero while preserving differentiability, thereby inducing sparsity without abrupt weight elimination. Alternatively, a continuous binary mask may be applied to the weights, with mask values learned using a constrained sigmoid or Gumbel-softmax relaxation to maintain end-to-end trainability.

In some embodiments, such sparsity-inducing operations are applied within the compressible data structure 218 during the joint fine-tuning and compression 110a, such as during the method 200a, process governed by the composite objective function 220. The compressible data structure 218 retains the expressive capacity of the original weight matrix 302 while enabling reduced resource usage.

FIG. 4 is a schematic diagram illustrating determination 204 of the composite objective function 220, according to some embodiments of the present disclosure. FIG. 4 is explained in conjunction with elements from FIG. 1, FIG. 2A, FIG. 2B, and FIG. 3.

In some embodiments, the composite objective function 220 is a loss function associated with the joint fine-tuning or training and compression of the neural network model 108 which drives the optimization of the neural network model 108. In some embodiments, the composite objective function 220 has two components—a task loss component 402 and a compression loss component 404. The task loss component 402 provides computations to evaluate predictive performance of the neural network model 108 with respect to a target task. In that sense, the task loss component 402 governs fine-tuning of the neural network model 108 during training so as to achieve high predictive performance.

The compression loss component 404 on the other hand, provides computations associated with penalizing resource usage characteristics of the neural network model 108. For example, the resource usage characteristics may be measured by one or more parameter dimensionality, parameter sparsity, or numerical precision, of the neural network model 108. In this sense, the compression loss component 404 governs the compression of the neural network model 108. In some embodiments, the task loss component 402 and the compression loss component 404 are independently computed and jointly used to update the model parameters during training of the neural network model 108. The task loss component 402 quantifies the prediction error of the model on a given target task using standard metrics such as cross-entropy or MSE, depending on the nature of the problem. In parallel, the compression loss component 404 evaluates the efficiency characteristics of the neural network model 108, including—but not limited to—the dimensionality of parameters, their sparsity pattern, and the numerical precision used in computation.

The composite objective function 220 integrates both predictive performance based loss and resource usage based loss, which may both be iteratively and jointly updated during optimization/training of the neural network model 108. As a result, the optimized neural network model 112 is obtained in a single training pipeline, without suffering from problems associated with disconnected or sequential fine-tuning and compression pipelines which were discussed earlier in FIG. 1. Thus, the composite objective function 220 is advantageous in providing a computationally efficient and resource usage optimized neural network model 112.

In some embodiments, both the loss components feed into a single optimization step using gradient-based optimization, allowing the neural network model 108 to learn weights and structures that are both performant and efficient. This alignment is critical to ensure that compression does not occur at the cost of degraded task performance, which is a common pitfall in traditional post hoc compression schemes.

In some embodiments, the compression loss component 404 includes a regularization term 406 which is added to promote at least one of weight sparsity, matrix rank reduction, and reduced numerical precision, in the overall loss. To that end, the regularization term 406 may be progressively changed to adjust one or more of the parameter sparsity, matrix rank, and numerical precision over successive iterations of the iterative optimization process 222 performed for the joint fine-tuning and compression of the neural network model 108. For example, the compression loss component 404 includes the regularization term 406, denoted as λ.

In some embodiments, the composite objective function includes a feature alignment loss component 408.

In some embodiments, the feature alignment loss component 408 serves as the regularization term 406 for the compression loss component 404 that promotes weight sparsity, matrix rank reduction, or reduced numerical precision. The feature alignment loss component 408 provides computations to minimize a difference between intermediate representations produced by the compressible data structure 218 and corresponding representations produced by a non-compressed reference structure. To that end, in some embodiments, the feature alignment loss component 408 is weighted by a dynamic regularization coefficient that decreases during optimization, such that the influence of the feature alignment loss component 408 diminishes over time. For example, the feature alignment loss component 408 may be weighted by the dynamic regularization coefficient γ that may decrease from 1 to 0 during different iterations of the iterative optimization process 222.

As an example, in some embodiments, the composite objective function 220 is defined as:

Lₜₒₜₐₗ=Lₜₐₛₖ+λL_{comp}+γL_{feat} (5)

where Lₜₒₜₐₗ forms the composite objective function 220, Lₜₐₛₖ forms the task loss component 402, L_{comp} forms the compression loss component 404, and L_{feat} forms the feature alignment loss component 408. Here λ and γ form tunable hyperparameters controlling the relative importance of compression and feature consistency losses. The composite objective function 220 integrates different types of losses described above, specifically, the task loss component 402 and the compression loss component 404, which ensures that the neural network model 108 is optimized not only to perform the target task effectively but also to yield a model that is compact and suitable for deployment in resource-constrained environments such as mobile or edge devices.

Some examples of practical implementation of these different types of losses are provided in the description that follows.

In some embodiments,

Lₜₒₜₐₗ=Lₜₐₛₖ{y,ŷ}+γL_{feat}{Fₜ,Fₛ} (6)

where

$${L}_{feat} \{ {F}_{t} , {F}_{s} \} = \frac{1}{m} {\sum }_{i = 1}^{m} MSE ( {F}_{{t}_{i}} , {F}_{{s}_{i}} ) .$$

Here y and ŷ are the ground truth and outputs of the neural network model 108, Fₛ_{ᵢ} and Fₜ_{ᵢ} are outputs of i-th linear layer from student and teacher branches associated with the neural network model 108, respectively. More description of student and teacher branches are provided in conjunction with FIG. 5A and FIG. 5B. Using the composite objective function 220 as described above, in the iterative optimization process 222, enables providing more layer-wise guidance at the beginning of the distillation iterations of the neural network model 108 and gradually relaxing this guidance.

FIG. 5A illustrates a schematic diagram of the iterative optimization process 222 performed by the neural network model 108, according to an embodiment of the present disclosure. FIG. 5A is explained in conjunction with elements from FIG. 1, FIG. 2A, FIG. 2B, FIG. 3 and FIG. 4. The iterative optimization process 222 is executed, for example, by operations 206 and 208 of the method 200a described in FIG. 2A.

The neural network model 108 may undergo training by the gradient-based optimization process 222, that is performed to update the parameters associated with the neural network model 108 with respect to the composite objective function 220. During training, as per the iterative optimization process 222, both the traditional model weights of the original weight matrix 302, W, and the parameters of the compressible data structure 218 are adjusted concurrently. This process of optimization continues until a termination condition is met, such as the termination condition described in operation 208 of the method 200a. Upon completion of the iteration, an output model is produced that includes the optimized compressible data structure and the optimized neural network model 112, that is ready for deployment.

The neural network model 108 includes a plurality of layers, and the iterative optimization process 222 is conducted for each layer of the neural network model 108. Each layer may be a linear layer. To that end, FIG. 5A illustrates the iterative optimization process 222 conducted for a single layer of the neural network model 108, for the purpose of illustration only, and not to limit the scope of the present disclosure. The layer of the neural network model 108 shown in FIG. 5A includes a layer input 502, X, which is sent to two parallel paths-a teacher path 504 and a student path 506. The teacher path 504 includes a fixed pretrained weight matrix 508, such as the original weight matrix W shown in FIG. 3, that forms a reference output. The student path 506 includes a trainable output 512 that is generated using the compressible data structure 218. During successive iterations of the iterative optimization process 222, a weight assigned to the reference output or the fixed pretrained weight matrix 508 is progressively decreased 510 according to a continuous decay function. Also, a weight assigned to the trainable output 512 is progressively increased 514 over successive iterations according to the continuous decay function. In an embodiment, the decay function is defined by:

$${α}_{t} = \{ \begin{matrix}1 - sin ( \frac{π t}{2 T} ) & if t \leq T \\ 0 & otherwise\end{matrix} \qquad ( 7 )$$

where t is the current iteration number, and T is the number of decaying iterations, which is set as 80% of total number of iterations. Further, the reference output from the teacher path 504, and the trainable output 512 from the student path 506 are combined 516 according to the decay function at to generate a layer output 518, Y, of the layer of the neural network model 108 as a weighted combination of the reference output or the fixed pretrained weight matrix 508, and the trainable output 512. FIG. 5B illustrates a flowchart of a method 520 showing an example implementation of the iterative optimization process 222 shown in FIG. 5A. The method 520 provides a joint fine-tuning, distillation, and compression workflow for the neural network model 108 where progressive distillation from the teacher path 504 to the student path 506 is conducted.

In an example, the layer output 518 of each linear layer of the neural network model 508 is denoted as Y=αY_{teacher}+α′Y_{student}, where α decreases from one to zero according to

$${α}_{t} = \{ \begin{matrix}1 - sin ( \frac{π t}{2 T} ) & if t \leq T \\ 0 & otherwise\end{matrix}$$

In some embodiments, to maintain the total power from both paths—the teacher path 504 and the student path 506 to be equal to one, an additional variable is defined as

$${α}_{t}^{′} = \sqrt{1 - {α}_{t}^{2}} .$$

In some embodiments, the overall layer output 518 is given as:

$$Y = {a}_{t} {\underbrace{( {W}_{0} X + {b}_{0} )}}_{teacher} + \sqrt{1 - {α}_{t}^{2}} {\underbrace{( WX + b )}}_{student} , \qquad ( 8 )$$

where decay factor αₜ is set as in decrease.

Referring back to FIG. 5B, the method 520 produces a blended layer output during iterative optimization of the neural network model 108, in accordance with one or more embodiments of the present disclosure.

As shown, the layer input 502 is fed into two parallel computational paths—the teacher path 504 which uses a fixed, pretrained weight matrix and bias—denoted as W₀ and b₀ to produce the reference output Y_{teacher}=W₀X+b₀.

Simultaneously, the student path 506 uses the trainable, compressible data structure 218 (e.g., a low-rank or sparse representation of weights) to produce the trainable output 512 Y_{student}=WX+b where W and b are parameters subject to optimization. At block 522, combined 516 output including a weighted combination of these two outputs Y_{teacher}=W₀X+b₀ and Y_{student}=WX+b is used to compute the final layer output Y for the layer. The blending is governed by the time-dependent decay factor α or αₜ, which is initialized to 1 and gradually reduced over successive training iterations. Specifically, the output is computed using:

$$Y = {α}_{t} {T}_{teacher} + \sqrt{1 - {α}_{t}^{2}} {Y}_{student}$$

As training progresses, the value of αₜ is decreased smoothly (e.g., using a sinusoidal or linear schedule), thereby reducing the influence of the fixed teacher weights while increasing reliance on the optimized compressible data structure 218. Finally, the layer output 518 is generated which is then propagated forward through the neural network model 108. This progressive interpolation allows the neural network model 108 to transition stably from pretrained initialization to a fully compressed and fine-tuned representation, improving performance while reducing resource usage. The illustrated approach mitigates abrupt accuracy drops by leveraging the stability of the pretrained model during early training phases and gradually phasing in the more efficient student model.

In some embodiments, iterative optimization process 222 is a gradient-based optimization process that is implemented as a feedback loop. To that end, the gradient-based optimization is implemented using a stochastic gradient descent process or a first-order optimization process. The neural network model 108 begins training with initialized parameters, including those in the compressible data structure 218. In each iteration, gradients are computed with respect to the composite objective function 220 and are used to update the neural network model's 108 parameters. The loop continues until a termination condition, such as defined in operations 206 and 208 of the method 200a, is satisfied. This condition can be dynamic or static—for example, based on the model's convergence, a fixed number of epochs, or external performance metrics on a validation set.

The output of this training pipeline is the output model, which is the optimized neural network model 112, which includes the fully trained and optimized compressible data structure 218. This output model is resource-aware by design and ready for deployment without requiring any further compression or post-processing. The joint nature of the optimization ensures that the optimized neural network model 112 has been compressed in a task-aware and data-dependent manner, which would not be possible using rigid, pre-specified pruning or quantization heuristics.

Some embodiments are based on joint fine-tuning and distillation of the neural network model 108 to improve the model compression and adaptation capabilities. This approach extends general tasks beyond computer vision tasks to jointly fine-tune and prune convolutional neural networks iteratively. Specifically, the present disclosure uses a decay factor to reduce the influence of pretrained teacher path 504 smoothly, discarding the switching between fine-tuning and compression. The inclusion of fine-tuning in the compression process leads to much higher compression ratios, while maintaining comparable accuracy. In some embodiments, as discussed in conjunction with FIG. 3, the structure of the student path 506 with a basic low-rank decomposition is further compressed with pruning techniques. Further, the performance of the neural network model is enhanced through more careful design of the transition from the teacher path 504 to the student path 506. Some embodiments further splits into multiple branches for flexible rank controls.

During fine-tuning, the student path 506 gradually replaces the teacher path 504, which reduces its influence on the output to zero, while maintaining the total power from both branches equal to 1. Some embodiments further consider multiple mask scheduling to adjust the influence of individual eigenvectors of pretrained weights and low-rank adapters. Yet another embodiment integrates power decay with numerical precision and sparsity scheduling to increase the computational efficiency. For example, iterative hard thresholding is conducted over finetuning iterations, and its threshold value is gradually adjusted to progressively prune the number of model parameters.

The present disclosure also employs novel extensions of activation-aware initialization. To further compress the model, pruning is jointly applied on top of this low-rank decomposition. The entire pipeline integrates fine-tuning, knowledge distillation, low-rank decomposition, and pruning, and directly producing a compact and efficient model.

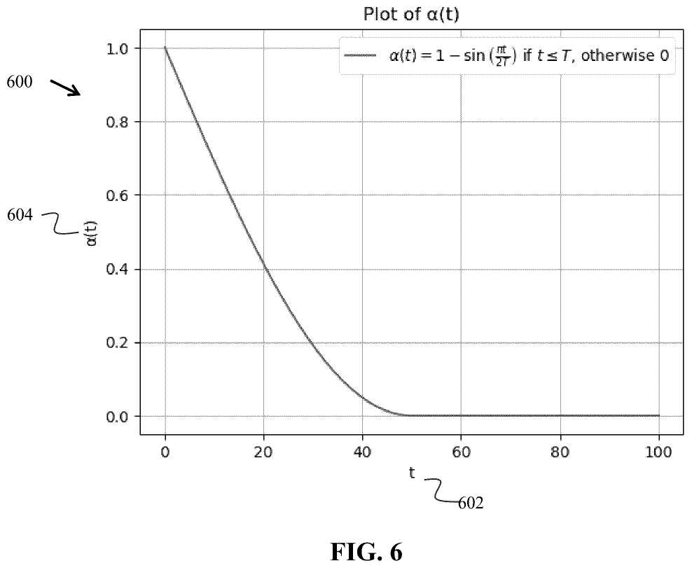

FIG. 6 illustrates a graphical plot 600 showing influence of the decay function at on the performance of the neural network model 108, according to an embodiment of the present disclosure. FIG. 6 is explained in conjunction with elements from FIG. 5A and FIG. 5B. The graphical plot 600 includes time t, 602, represented on the X-axis and the decay function αₜ as a function of time α(t), 604, represented on the Y-axis. The decay function αₜ represents the power of the two different paths—the teacher path 504 and the student path 506, as a function of iterations t. In this example, there are total T=50 decaying iterations. The branch power decay factor

$$α ( t ) = 1 - sin ( \frac{π t}{2 T} )$$

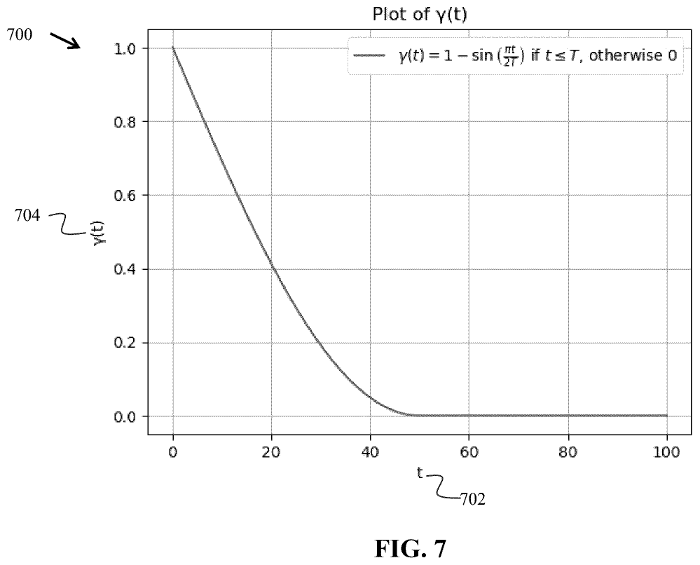

when t≤T, and remains 0 when t>T. Further, apart from the decay function αₜ, the regularization coefficient γ also varies for different iterations of the iterative optimization process 222. The variation of regularization coefficient γ over different iterations of the iterative optimization process 222 is shown in FIG. 7.

FIG. 7 illustrates a graphical plot 702 showing an example of the decaying of layer-wise regularization factor γ 704 shown in Y-axis w.r.t. iterations t 702 shown on the X-axis. In this example, there are total T=50 decaying iterations. When

$$t \leq T , γ ( t ) = 1 - sin ( \frac{π t}{2 T} ) ,$$

and then remains 0 when t>T.

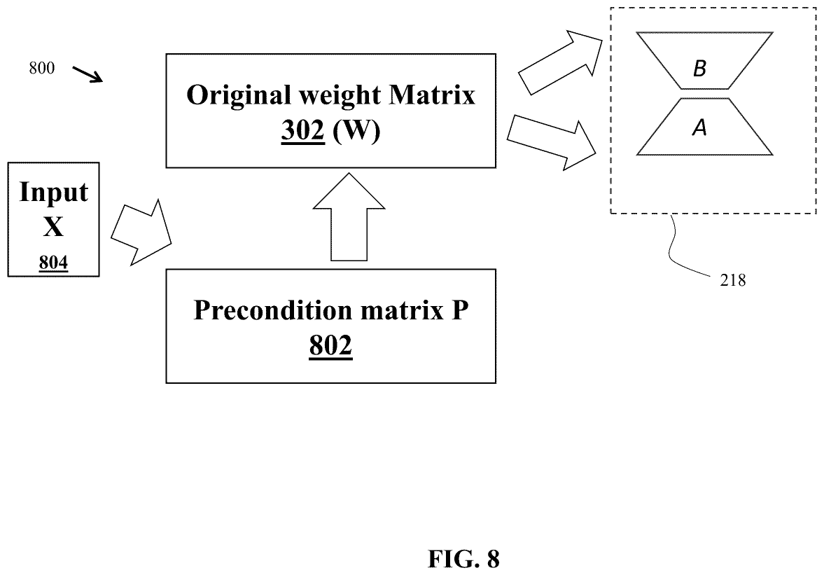

In some embodiments, the iterative optimization process 222 uses different types of compression strategies. Some of these compression strategies are illustrated in FIG. 8-FIG.

FIG. 8 is a schematic diagram 800 illustrating an example of initialization of the low-rank matrices A and B based on original weight matrix 302, W and a precondition matrix 802, P. The low rank matrices A and B form the compressible data structure 218 for a particular layer input 804 of the neural network model 108.

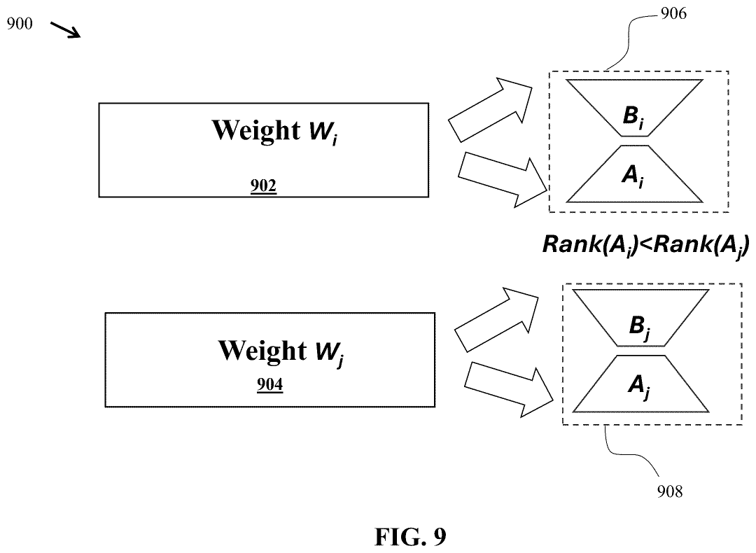

FIG. 9 illustrates a schematic diagram 900 illustrating an example of disclosed compressed representations where the ranks of the low-rank matrices are adaptive/nonuniform for different components, for the neural network model. For example, for a first weight matrix 902 a first compressible data structure 906 is generated. For a second weight matrix 904, a second compressible data structure 908 is generated such that the rank of Aᵢ is different from the rank of Aⱼ.

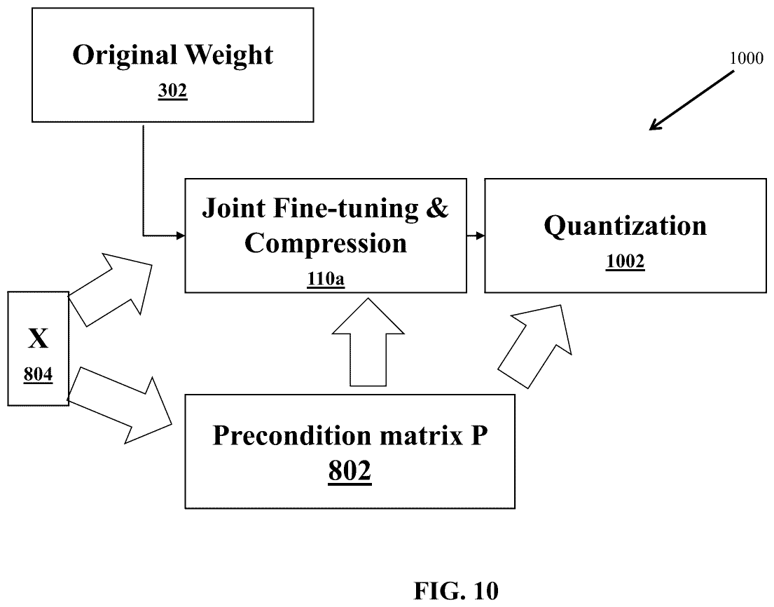

FIG. 10 illustrates a schematic diagram 1000 showing example operations performed on the input X 804, using the joint fine-tuning and compression 110a process performed by the neural network model 108. In this example embodiment, based on the original weight matrix 302 and the precondition matrix P 802, the joint fine-tuning and compression 110a process further performs quantization on the low-rank matrices of the compressible data structure 218. Firstly, the compressible data structure 218 is derived and then simply quantization 1002 is done on the compressible data structure 218 produced by the joint fine-tuning and compression 110a process.

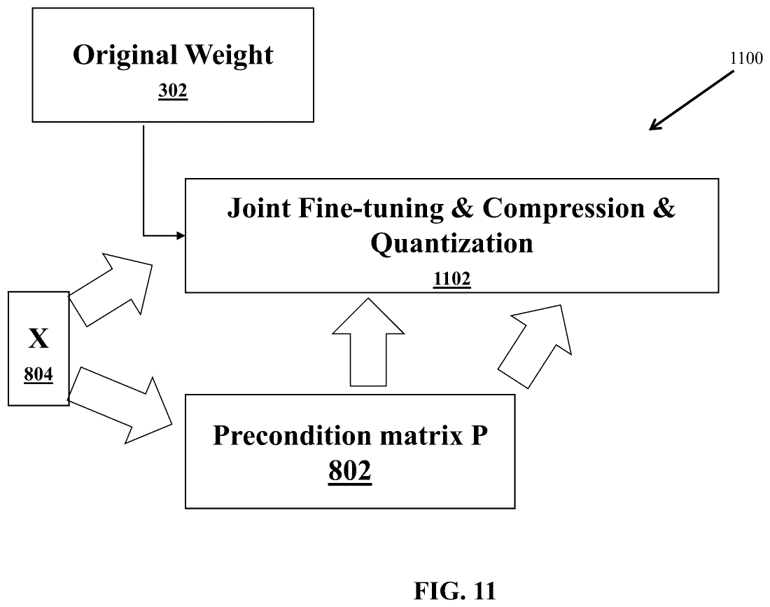

In another embodiment, as shown in FIG. 11, a schematic diagram 1100 is shown where joint fine-tuning and compression as well as quantization operation 1102 is performed simultaneously by the neural network model 108. For example, the quantization uses pre-conditioning matrix for iterative rounding projection for improved accuracy and efficiency. For joint quantization, some embodiments use a proper initialization for the iterative optimization. Some embodiments use a progressive quantization over the iterative process. For example, the iterative quantization reduces the quantization bits over the iteration count. This progressive quantization significantly improves the accuracy of the neural network model 108.

In some embodiments, the joint fine-tuning and compression 110a process is followed by other operations.

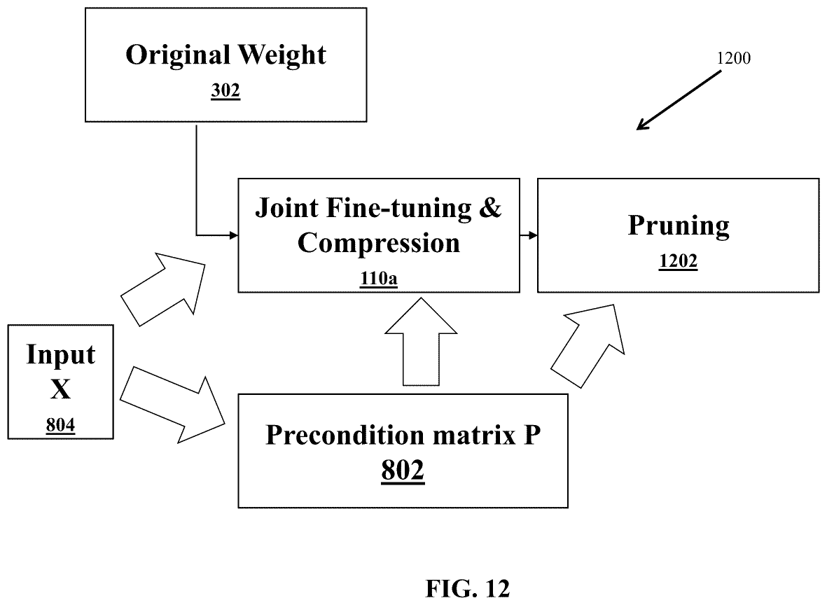

FIG. 12 illustrates a schematic diagram 1200 showing that based on the original weight matrix 302 and the precondition matrix P 802, the joint fine-tuning and compression 110a process is followed by a pruning operation 1202 (on the low-rank matrices of the compressible data structure 218).

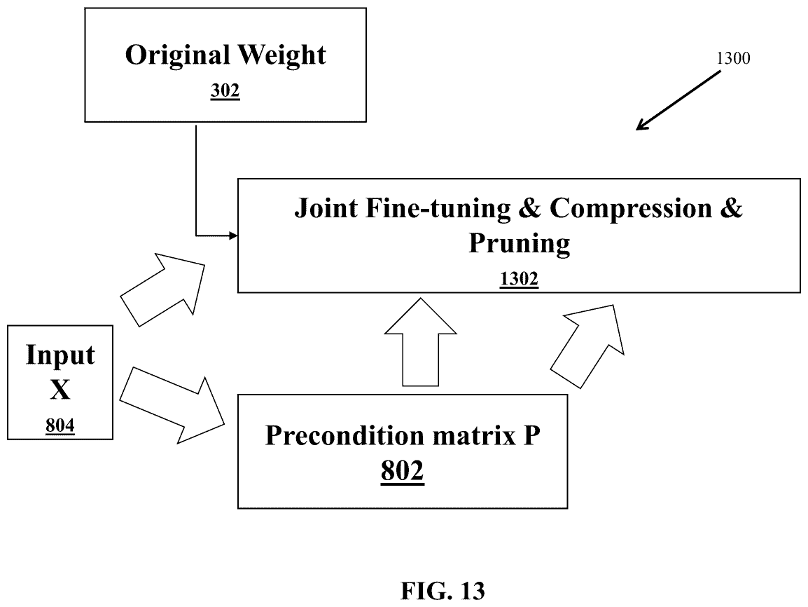

FIG. 13 illustrates a schematic diagram 1300 showing that based on the original weight matrix 302 and the precondition matrix P 802, the joint fine-tuning and compression 110a process and the pruning operation 1202 (on the low-rank matrices of the compressible data structure 218) are performed simultaneously as a joint fine-tuning and compression and pruning operation 1302. For example, the pruning uses pre-conditioning matrix for iterative sparsification projection for improved accuracy and efficiency of the neural network model. For joint pruning, some embodiments use iterative hard or soft thresholding to improve the accuracy and efficiency. Some embodiments use a proper initialization for the iterative optimization. Some embodiments use a progressive pruning over the iterative process. For example, the iterative hard thresholding increases the compression ratio over the iteration count. This progressive pruning significantly improves the accuracy of the neural network model 108.

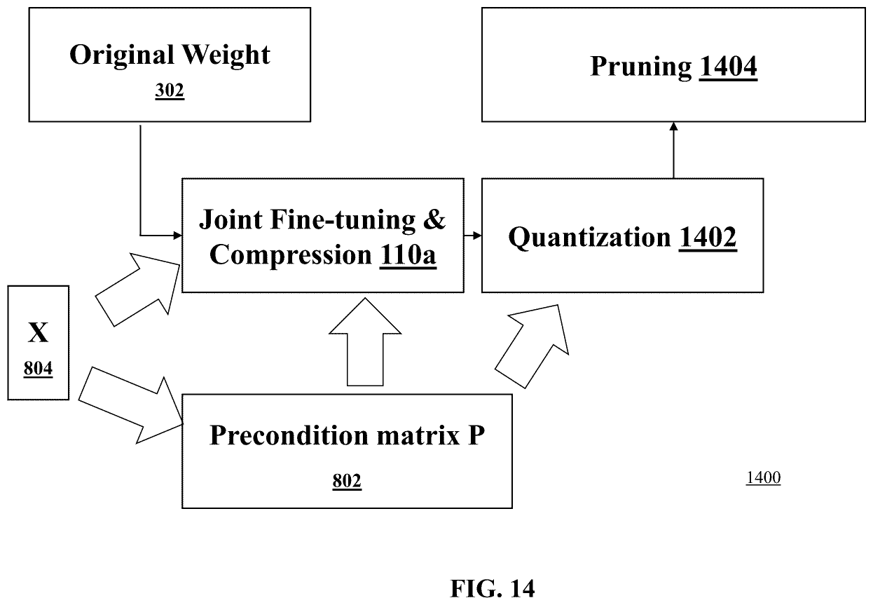

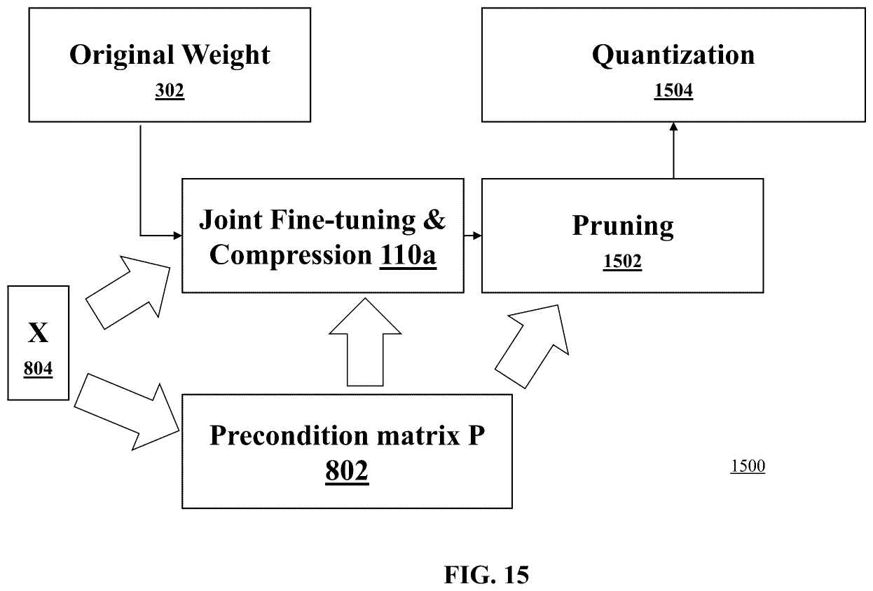

FIG. 14 illustrates a schematic diagram 1400 showing that based on the original weight matrix 302 and the precondition matrix P 802, the joint fine-tuning and compression 110a process is followed by a quantization operation 1402 and a pruning operation 1404 that are performed further on the low-rank matrices obtained as the compressible data structure 218. In the example shown in FIG. 14, the joint fine-tuning and compression 110a process is followed by sequential quantization operation 1402 and then the pruning operation 1404. An alternate representation is shown in FIG. 15, where the order of these operations is reversed.

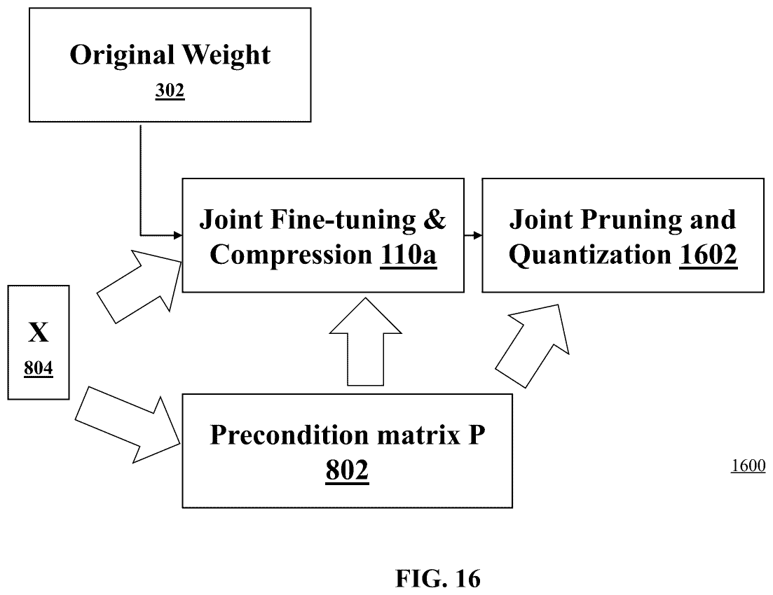

FIG. 15 illustrates a schematic diagram 1500 showing that based on the original weight matrix 302 and the precondition matrix P 802, the joint fine-tuning and compression 110a process is followed sequentially by, first a pruning operation 1502 and then a quantization operation 1504 that are performed further on the low-rank matrices obtained as the compressible data structure 218 as a consequence of execution of the joint fine-tuning and compression 110a process. Another possible variation to this sequence of operations shown in FIG. 14 and FIG. 15 is shown in FIG. 16.

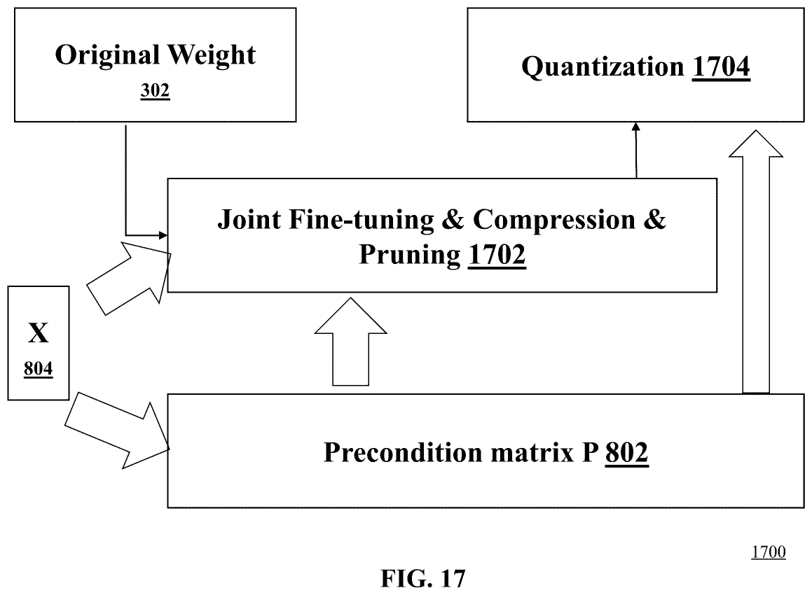

FIG. 16 illustrates a schematic diagram 1600 showing that based on the original weight matrix 302 and the precondition matrix P 802, the joint fine-tuning and compression 110a process is followed by a joint pruning and quantization operation 1602, performed further on the low-rank matrices obtained as the compressible data structure 218 as a consequence of execution of the joint fine-tuning and compression 110a process. For example, the joint pruning and quantization operation 1602 uses the pre-conditioning matrix 802 for iterative sparsification projection and iterative rounding projection for improved accuracy and efficiency. For the joint pruning and quantization operation 1602, some embodiments use a proper initialization for the iterative optimization process 222. Some embodiments use a progressive pruning and quantization over the iterative optimization process 222. For example, an iterative hard thresholding operation may be performed, that increases the compression ratio over the iteration count, and the iterative quantization reduces the quantization bits over the iteration count. This progressive pruning and quantization significantly improves the accuracy of the neural network model 108. In some other embodiments, other variations of operations are used. An example is shown in FIG. 17.

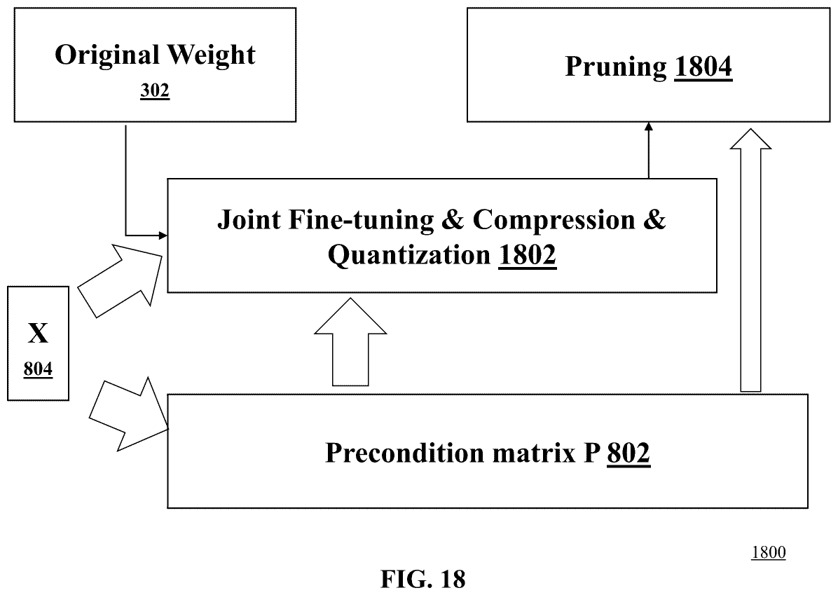

FIG. 17 illustrates a schematic diagram 1700 showing that based on the original weight matrix 302 and the precondition matrix P 802, the joint fine-tuning and compression process is performed jointly with compression and pruning operations, in the form of a joint fine-tuning and compression and pruning operation 1702, to provide the compressible data structure 218. For example, the compressible data structure 218 is obtained when the original weight matrix 302 is jointly fine-tuned and low-rank compressed and pruned 1702, and it is further quantized 1704. Some embodiments use a progressive rank reduction and pruning over the iterative process. In some embodiments, this order of operations may be changed. This is illustrated in FIG. 18.

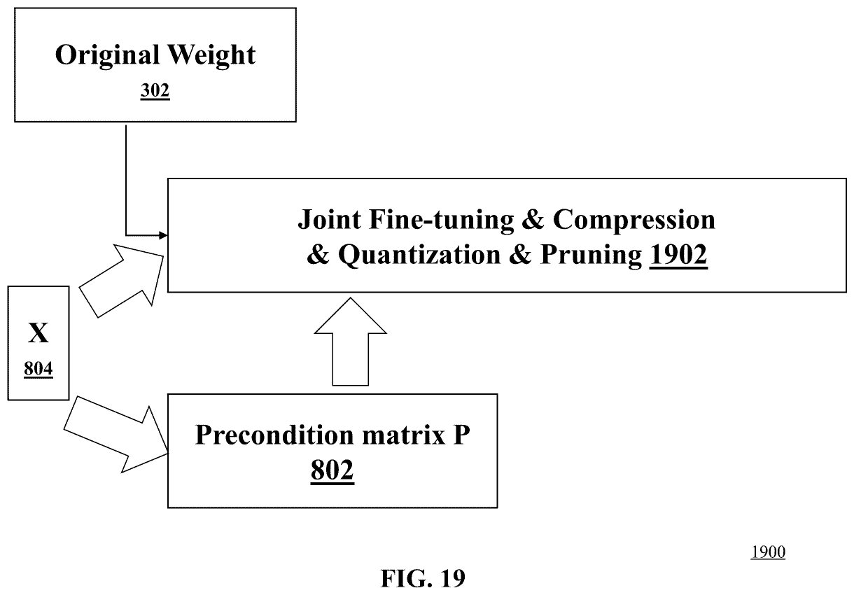

FIG. 18 illustrates a schematic diagram 1800 showing that based on the original weight matrix 302 and the precondition matrix P 802, the joint fine-tuning and compression process is performed jointly with compression and quantization operations, in the form of a joint fine-tuning and compression and quantization operation 1802, to provide the compressible data structure 218. For example, the compressed representations where the original weight matrix is jointly fine-tuned and low-rank compressed and quantized, and it is further pruned by a pruning operation 1804. Some embodiments use a progressive rank reduction and quantization over the iterative process. Another variation of the order of these operations is shown in FIG. 19.

FIG. 19 illustrates a schematic diagram 1900 showing that based on the original weight matrix 302 and the precondition matrix P 802, the joint fine-tuning and compression process is performed jointly with compression and quantization and pruning operations, in the form of a joint fine-tuning and compression and quantization and pruning operation 1902, to provide the compressible data structure 218. For example, the original weight matrix 302 is jointly fine-tuned and low-rank compressed and quantized as well as pruned. Some embodiments use a progressive rank reduction, pruning, and quantization over the iterative process.

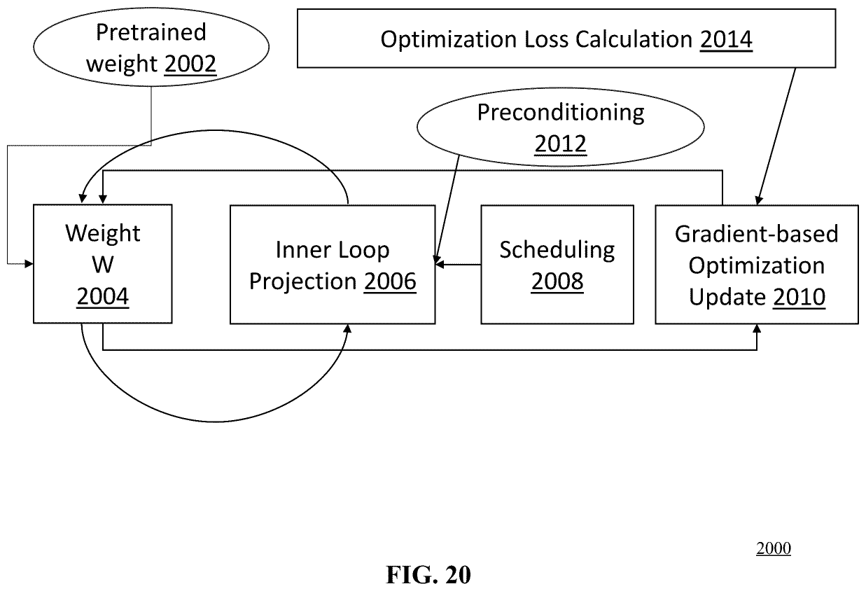

FIG. 20 illustrates a schematic diagram of an exemplary optimization framework for fine-tuning neural network weights for neural network model using pretrained parameters 2002, inner-loop projection techniques 2006, preconditioning mechanisms 2012, and scheduled gradient-based updates 2010, in accordance with one or more embodiments of the present disclosure. The optimization framework shown in the schematic diagram 2000 may be implemented by the iterative optimization process 222 in some embodiments.

Based on following the framework shown in FIG. 20, the iterative optimization process 222 begins with the set of pretrained weights 2002, which may originate from a base model trained on a large-scale dataset. These pretrained weights 2002 are provided to a weight module 2004, representing the current set of learnable parameters W subject to optimization during fine-tuning. The weight module 2004 is part of a looped architecture that supports iterative refinement.

During optimization, the weights are processed through an inner loop projection module 2006, which enforces constraints or transformations on the parameter updates. This may include low-rank projection, orthogonalization, or sparsity enforcement (e.g., pruning or thresholding) as part of a structured update mechanism. The projection module is applied in the inner loop to ensure that updates remain within a desirable subspace or obey resource constraints.

A scheduling module 2008 governs the timing and scaling of the gradient-based updates applied to the model parameters. This scheduler may adaptively adjust learning rates, blending weights, or temperature parameters over time, and may also implement decay strategies for shifting reliance from pretrained weights toward updated parameters.

Projected parameters and scheduled update signals are passed to the gradient-based optimization update module 2010, which performs the core parameter updates using gradient descent or its variants (e.g., Adam, RMSProp). The gradient-based optimization update module 2010 may incorporate dynamic learning rates, momentum, or second-order information.

To improve convergence and stability, a preconditioning module 2012 may optionally be applied to rescale or transform gradients prior to application. Preconditioning may involve the use of historical gradient statistics, curvature information, or Fisher information matrices.

The entire optimization pipeline is supervised by an optimization loss calculation module 2014, which computes a composite loss function including task performance (e.g., cross-entropy) and regularization or compression penalties (e.g., low-rank, sparsity, quantization). This loss function guides the update of parameters and may also inform decisions within the scheduler and preconditioner.

The architecture shown in FIG. 20 enables stable and efficient fine-tuning of the neural network model 108, especially in scenarios involving model compression, transfer learning, and domain adaptation. The integration of structured projections and scheduling into the optimization loop allows for a controlled transition from pretrained representations to task-specific compressed forms.

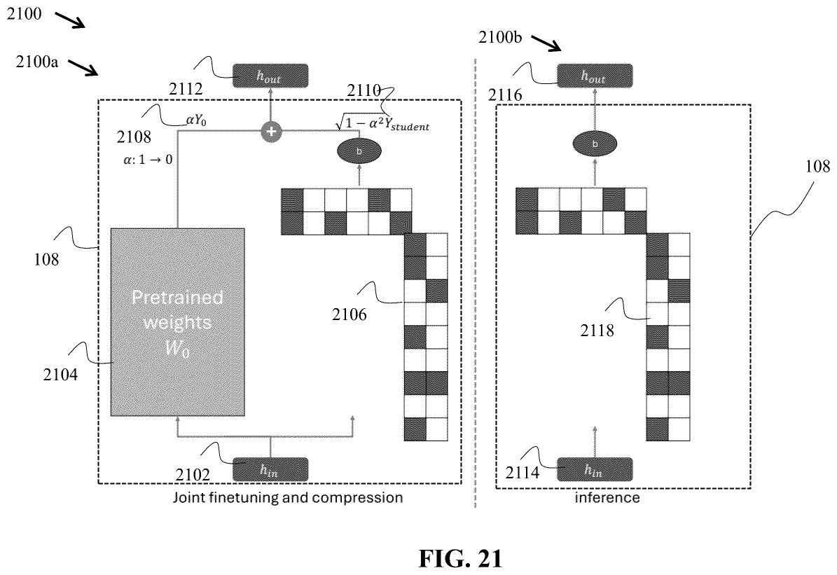

FIG. 21 illustrates a schematic diagram 2100 showing an example implementation of the joint fine-tuning and optimization process 110a for the neural network model 108, showing training and inference phases side-by-side, according to an embodiment of the present disclosure. The schematic diagram 2100a on the left illustrates training phase for the neural network model 108 and schematic diagram 2100b on the right illustrates inference phase for the neural network model 108.

In the training phase, the compression of the neural network model 108 is conducted along with fine-tuning as per the joint fine-tuning and compression process 110a discussed in FIG. 1 and further in the method 200a of FIG. 2A and the following figures. The inclusion of fine-tuning in the compression process leads to much higher compression ratios, while maintaining comparable accuracy for the neural network model 108. The training methodology shown in the schematic 2100a of FIG. 21 incudes a teacher branch with a fixed pretrained weight matrix 2104, denoted as Wₒ, and a student branch having a compressible data structure 2106. The compressible data structure 2106 is equivalent to the compressible data structure 218 discussed earlier. In the example shown in FIG. 21, the structure of the student branch with a basic low-rank decomposition maybe be further compressed with pruning techniques. Further, the performance may be enhanced through more careful design of the transition from the teacher to the student branch. The transitioning from the teacher branch to the student branch is governed by the decay factor α and by the composite objective function 220 discussed earlier. Further, the transitioning from the teacher branch to the student branch is done as per the iterative optimization process 222 discussed above in conjunction with previous figures.

To that end, in the training phase shown in the schematic diagram 2100a, each input 2102 hᵢₙ to a layer of the neural network 108 is propagated to the two parallel branches—the teacher branch and the student branch, where the weight assigned to an output generated by each branch is governed by the decay factor α (equivalent to the decay function at defined in equation 7). The final output 2112, hₒᵤₜ of the layer of the neural network model 108 is given as a combination of the outputs of the teacher branch and the student branch, as per a relation:

hₒᵤₜ=αYₒ+\sqrt{1−α²}Y_{student}

where αYₒ is an output of the teacher branch 2108 and \sqrt{1−α²}Y_{student} is an output of the student branch 2110.

As training progresses, the value of a is decreased smoothly (e.g., using a sinusoidal or linear schedule), thereby reducing the influence of the fixed teacher weights while increasing reliance on the compressible data structure 2106, which is also optimized as the training progresses. Finally, the layer output hₒᵤₜ is generated which is then propagated forward through the neural network model 108. This progressive interpolation allows the neural network model 108 to transition stably from pretrained initialization of the fixed pretrained weight matrix 2104 to a fully compressed and fine-tuned representation of the optimized compressible data structure 2106, improving performance while reducing resource usage. The illustrated training process thus mitigates abrupt accuracy drops by leveraging the stability of the pretrained model during early training phases and gradually phasing in the more efficient student model.

In some embodiments the trainable and compressed student branch is derived on the basis of low-rank approximation methods, as discussed earlier in conjunction with FIG. 3. Some embodiments further splits into multiple branches of the neural network model 108 for flexible rank controls.

During fine-tuning, the student branch gradually replaces the teacher branch, which reduces its influence on the output to zero, while maintaining the total power from both branches equal to 1. Some embodiments further consider multiple mask scheduling to adjust the influence of individual eigenvectors of pretrained weights and low-rank adapters. Yet another embodiment integrates power decay with numerical precision and sparsity scheduling to increase the computational efficiency. For example, iterative hard thresholding is conducted over finetuning iterations, and its threshold value is gradually adjusted to progressively prune the number of model parameters.

In some embodiments, further novel extensions of activation-aware initialization is used, as discussed earlier in FIG. 3. To further compress the neural network model 108, various approaches as discussed in FIG. 10-FIG. 20 may be used. Thus, the neural network model 108 is subjected to the joint fine-tuning and compression process 110a which includes an entire pipeline integrating fine-tuning, knowledge distillation, low-rank decomposition, and pruning, and directly producing a compact and efficient model. The training is conducted till an optimized neural network model, such as the optimized neural network model 112 shown in FIG. 1 is obtained. This optimization may be determined on the basis of the composite objective function 220 which may describe an overall loss function for the neural network model 108 as described earlier in conjunction with FIG. 4. For example, the composite objective function defines the overall loss as Lₜₒₜₐₗ=Lₜₐₛₖ+λL_{comp}+γL_{feat}.

In some embodiments, the training phase is conducted as per the method 200a of FIG. 2A, until a termination condition is met. After the training, the optimized neural network model 112 may be used for inference, as shown by the schematic diagram 2100b of FIG. 21.

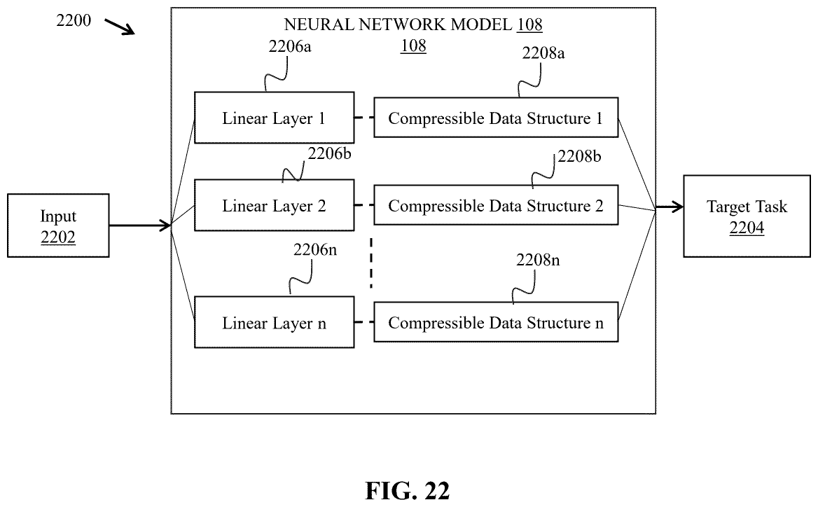

During inference, each layer of the neural network model 108 receives an input 2114 and propagates the input 2114 through an optimized compressible data structure 2118 identified as a result of training and generates an output 2116 as per the optimized compressible data structure 2118. This output is then propagated forward in the neural network model 108 to perform a task. In some embodiments, each layer of the neural network model 108 may be associated with a different compressible data structure. This is shown in FIG. 22.

FIG. 22 illustrates a schematic diagram 2200 showing plurality of layers of the neural network model 108 and their corresponding compressible data structures, according to an embodiment of the present disclosure.

The schematic diagram 2200 shows an example of operation of the neural network model 108 in which an input 2202 is given to the neural network model 108 to perform a task 2204. The input 2202 is propagated through a plurality of layers of the neural network model 108. To that end, the neural network model 108 includes a plurality of layers, such as a layer 2206a, a layer 2206b, a layer 2206n and the like, where n may be any arbitrary number. Each layer of the neural network model 108 is associated with an independently parameterized compressible data structure. For example, the layer 2206a is associated with a compressible data structure 2208a, the layer 2206b is associated with a compressible data structure 2208b, the layer 2206n is associated with a compressible data structure 2208n, and the like. To that end, each layer of the neural network model 108 has different number or shape of their weight matrices. During the iterative optimization process 222 of the neural network model 108, optimization is performed jointly across compressible data structures of the plurality of layers of the neural network model 108.

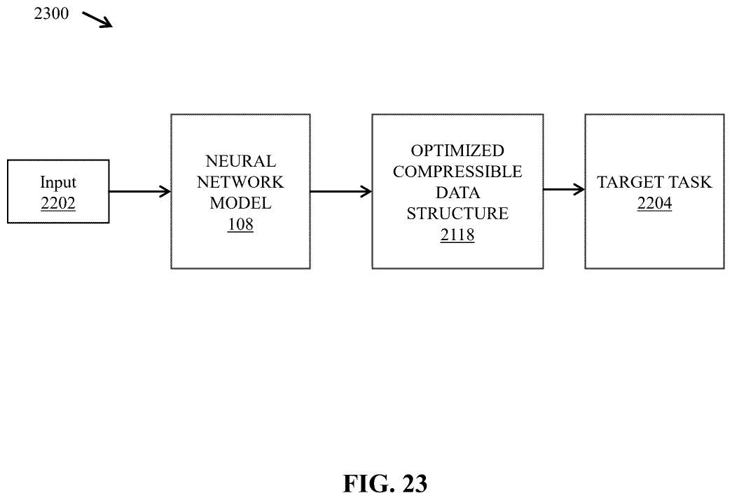

This configuration shown in the schematic diagram 2200 enables layer-wise compression flexibility, allowing each layer to adopt a compression form that best suits its representational role while still contributing to the overall performance of the neural network model 108. From a systems optimization standpoint, this architecture offers the technical advantage of global coordination across the neural network model 108: for example, earlier layers responsible for basic feature extraction may be compressed more aggressively, while later layers involved in semantic decision-making may retain higher precision or dimensionality. By optimizing the compressible representations of the plurality of layers jointly, rather than in isolation, the neural network model 108 may learn compression-aware inter-layer dependencies, which results in more efficient allocation of computational resources across the depth of the neural network model 108. This unified training process leads to superior compression-performance tradeoffs, reduces the need for heuristic per-layer tuning, and enables consistent convergence behavior during training and deployment of the neural network model 108. The neural network model 108 trained in this manner performs the target task 2204 efficiently and even under resource constrained environments, as depicted in FIG. 23.

FIG. 23 illustrates a schematic diagram 2300 showing a pipeline of task performance by the neural network model 108, according to an embodiment of the present disclosure. FIG. 23 is explained in conjunction with elements from FIG. 1, FIG. 2A, FIG. 2B, FIG. 3, FIG. 4, FIG. 5A, FIG. 5B, and FIG. 21, FIG. 22.

The neural network model 108 receives the input 2202 during inference. The input 2202 is propagated through the optimized compressible data structure 2118 that is deployed along with the deployment of the neural network model 108 during the inference phase. The deployed neural network model 108 may be the optimized neural network model 112. The deployed neural network model 108 then performs inference on the input data 2202 associated with the target task 2204.

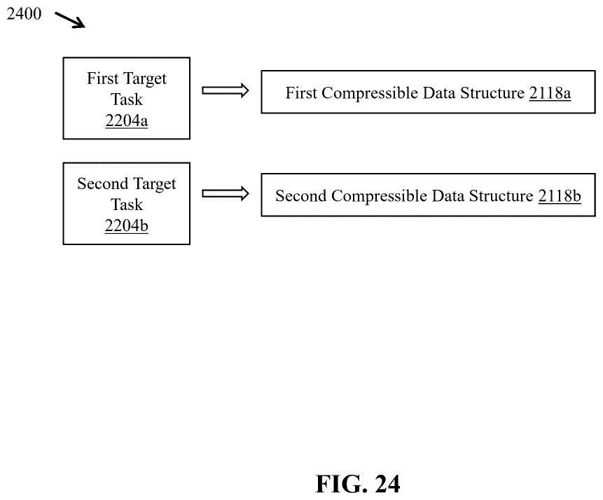

In some embodiments, the compressible data structures are different for different tasks. This is shown in FIG. 24.

FIG. 24 is a schematic diagram 2400 illustrating different compressible data structures associated with different tasks, according to an embodiment of the present disclosure. FIG. 24 is explained in conjunction with all the elements from FIG. 22 and FIG. 23.

The compressible data structure 2118 may be adapted specifically for the underlying target task 2204. To that end, an optimization performed for a first target task 2204a produces a first compressible data structure 2118a and an optimization performed for a second target task 2204b produces a second compressible data structure 2118b. That is, the form and learned parameters of the compressible data structure 2118 are not static or universal but instead are learned in a manner tailored to the target task 2204. For example, when optimizing the neural network model 108 for the first target task 2204a (e.g., image classification), the resulting first compressible data structure 2118a—such as low-rank factors, sparsity masks, or quantized encodings—is adapted to the data distribution, complexity, and representational requirements of that task. In contrast, if the same method, such as the method 200a of optimization of the neural network model 108, is applied to the second target task 2204b, distinct from the first target task 2204a (e.g., object detection or speech recognition), the optimization process yields the second compressible data structure 2118b that is structurally or parametrically different, reflecting the differing demands of the underlying task.

In some embodiments, the first compressible data structure 2118a and the second compressible data structure 2118b may differ in one or more of: matrix dimensionality, sparsity pattern, initialization parameters, or learned values of trainable parameters, depending on the underlying target task requirements. The differences between the first compressible data structure 2118a and the second compressible data structure 2118b may arise in one or more dimensions, including but not limited to: (i) matrix dimensionality (e.g., differing rank or shape of low-rank approximations), (ii) sparsity patterns (e.g., different sets of weights retained or masked depending on which features are most salient for each task), (iii) initialization parameters (e.g., different seeded values or priors used at the start of optimization), and/or (iv) learned values of trainable parameters (e.g., weights, thresholds, or quantization centroids optimized for each task).

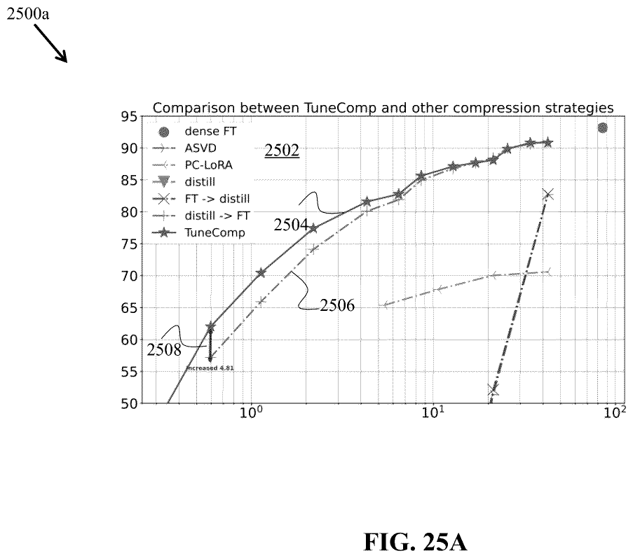

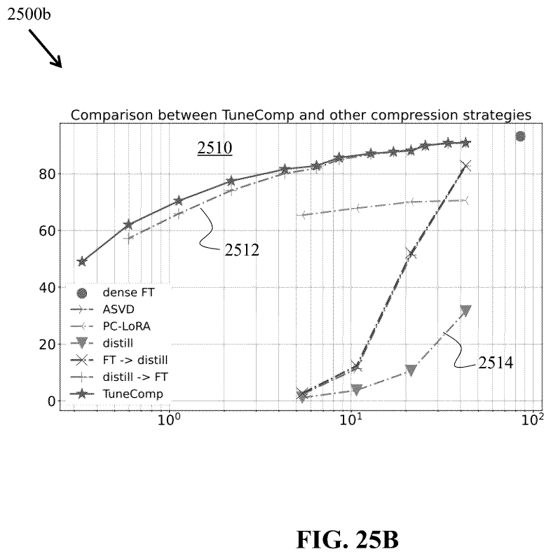

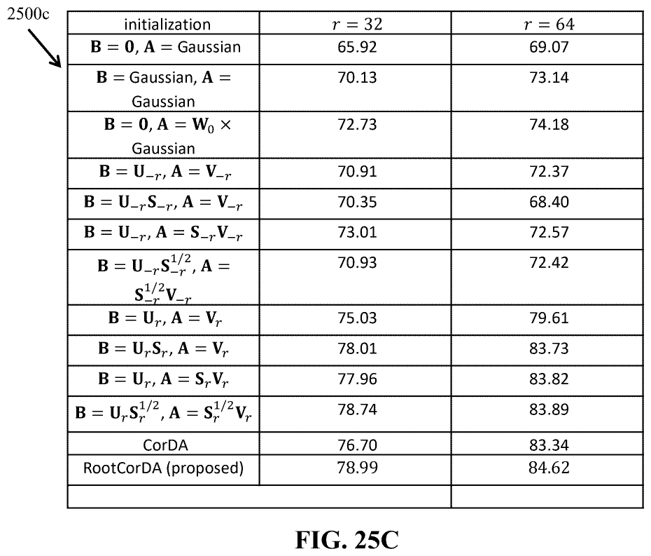

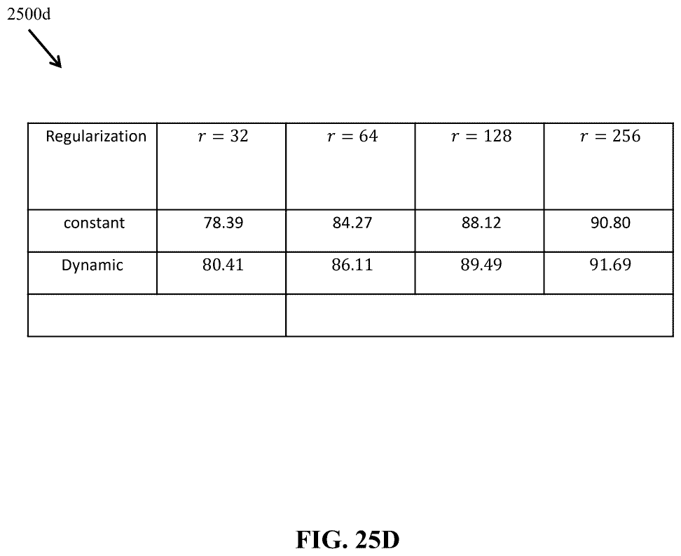

This task-adaptive nature of optimization of the compressible data structures of the neural network model 108 provides a significant technical advantage: it allows a single model architecture to be instantiated in multiple task-specific forms, each exhibiting high efficiency and performance without requiring manual redesign or static compression schemes. Such dynamic adaptability enhances deployment flexibility and supports multi-task learning scenarios, continual learning, and cross-domain optimization, all within the same optimization framework described in the various embodiments disclosed above. The enhanced performance of the neural network model 108, and the overall system 212 such a neural network model 108 is depicted in FIG. 25A and FIG. 25B.

FIG. 25A and FIG. 25B jointly illustrate the performance characteristics of the neural network model 108 trained by the joint fine-tuning and optimization process 110a, in comparison with other model tuning and model compression technologies, according to an embodiment of the present disclosure. For the purpose of illustration in FIG. 25A and FIG. 25B the joint fine-tuning and compression process 110a is referred to as TuneComp.

FIG. 25A illustrates a schematic diagram 2500a showing a graph 2502 which shows a comparison of the TuneComp process with other optimization strategies for a neural network model, such as the neural network model 108. The performance evaluation shown in the graph 2502 is based on evaluations done on transformer-based large models for two tasks, specifically, a Vision Transformer (ViT) model for image classification and Llama 2 for natural language processing. The evaluations include executing the TuneComp pipeline on the transfer learning task from ImageNet1K to CIFAR100 for the ViT-Base model, which is a transformer based structure that has 86M parameters. Similarly, the OneCycleLR scheduler is used and learning rate ranges from 7*10⁻⁵ to 3*10⁻³ and the best classification accuracy is recorded. The rank of the low-rank matrices of the student branch range over {32, 64, 128, 256}.

To validate the improvement of the joint fine-tuning and compression process 110a TuneComp, it was compared with a few widely used pipelines:
Fine-tune: baseline, no compression at all
Fine-tune→distill: first full (dense) fine-tuning of each linear layer, and then distill the model to compress
distill→fine-tune: distill to a small model first, and then fine-tune the small model⋅TuneComp (joint fine-tuning and compression process 110a): progressively distill, pruning and fine-tune simultaneously
distill only: baseline with only compression.

For the distill→FT and TuneComp cases, pruning ratios from 0.1 to 1 were taken. As shown by the Pareto lines in FIG. 25A, for the TuneComp curve 2504 accuracy increased 2508 by up to 4.8% compared with the curve 2506 for widely used distilling then fine-tuning 2506 when the model size is small. However, for larger model sizes, such as rank 128 and above, TuneComp curve 2504 shows similar performance with distill→FT curve 2506, indicating that TuneComp is a better choice across all model size.

FIG. 25B illustrates a schematic diagram 2500b showing another graph 2510 which shows a comparison of the TuneComp process with other optimization strategies and showing by curve 2512 that FT→distill is far better than curve 2514 for distill, which is reasonable. However, both of them failed at smaller model size. Further, at rank 256, FT→distill is even better than PC-LoRA, a baseline joint fine-tuning and compression method, while still worse our TuneComp. This demonstrates the limitations of the baseline joint fine-tuning and compression, which further emphasizes the advantages of TuneComp. Further FIG. 25C illustrates a table 2500C showing a comparison of initialization methods for the low-rank matrices B and A used in the compressible data structure 218, according to an embodiment of the present disclosure. As shown in the table 2500C, for Gaussian initialization, the evaluations were done by setting B=0, A=Gaussian; B=Gaussian, A=Gaussian. The results, found in table 2500C initialization, show that for the joint fine-tuning and compression case, initializing both low-rank matrices as Gaussian results in better performance, especially when the rank r is low. Also shown in FIG. 25C are weight-aware initialization strategies, which were compared with Nystrom initialization where B=0, A=W×Gaussian. The table 2500C also shows comparisons with many variants of SVD based initializations, for SVD based low-rank decomposition, selecting top r principle vectors works better than least r singular vectors, and is much better than simple Gaussian initialization and Nystrom initialization. Symmetrically assigning singular values into left and right singular vectors is often a good choice.

Also shown in table 2500c are the activation-aware initialization strategies where ⋅ CorDA initialization and Proposed RootCorDA initialization strategies were evaluated. The last few rows in the table 2500C show that CorDA cannot consistently outperform the weight-aware SVD initialization (Symmetric singular values with top-r singular vectors). However, RootCorDA outperforms CorDA.

In some embodiments, pruning strategies were also studied. For evaluating pruning effect, during joint fine-tuning and compression process 110a including distillation of the low-rank structure, pruning on the low-rank structure is simultaneously applied to each matrix B and A, and the pruning ratio can be predefined. It was observed in some embodiments that pruning 20% or 40% consistently outperforms the no pruning case, in terms of the accuracy-efficiency trade-off. However, pruning 60% or more may not have a better accuracy-efficiency trade-off.

In some embodiments, effect of regularization decay on the joint fine-tuning and compression process 110a was evaluated.

FIG. 25D illustrates a table 2500d showing a comparison of regularization decay strategy of the joint fine-tuning and compression process 110a with the constant regularization, according to an embodiment of the present disclosure. For constant regularization, γ=0.2. The results shown in the table 2500d show that dynamic regularization of the joint fine-tuning and compression process 110a achieves better performance that the constant regularization.

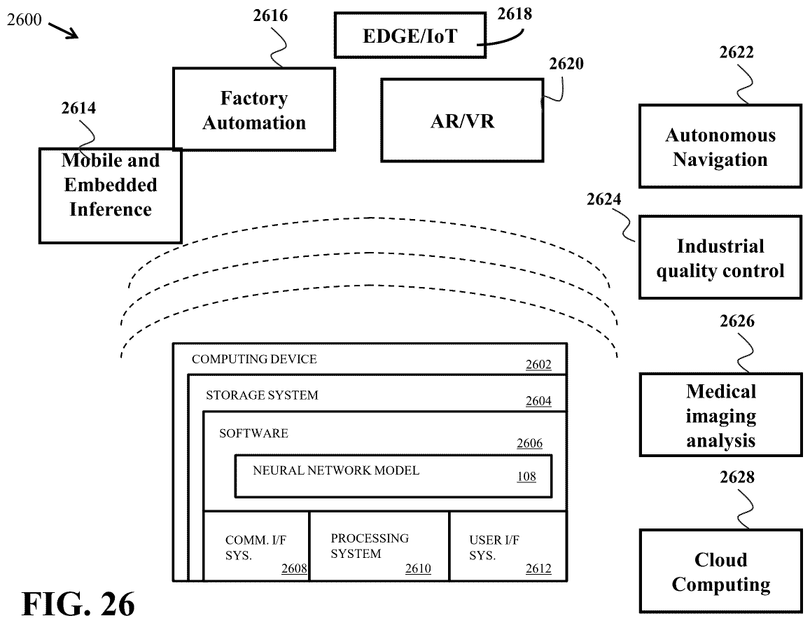

The joint fine-tuning and compression process 110a shows enhanced accuracy, improved performance, and optimum calculations for various applications, specifically resource constrained environments. Some applications of the joint fine-tuning and compression process 110a implemented by the neural network model 108 in the system 212 is shown in FIG. 26.

FIG. 26 illustrates a block diagram 2600 of a computing device 2602 that is representative of any system or collection of systems in which the various processes, programs, services, and scenarios disclosed herein may be implemented. The computing device 2602 is used to implement and/or embody the functionalities and operations performed by the system 212 including the neural network model 108.

Examples of the computing device 2602 include, but are not limited to, desktop and laptop computers, tablet computers, mobile computers, audio devices, and wearable devices. Examples may also include server computers, web servers, cloud computing platforms, and data center equipment, as well as any other type of physical or virtual server machine, container, and any variation or combination thereof.

The computing device 2602 may be implemented as a single apparatus, system, or device or may be implemented in a distributed manner as multiple apparatuses, systems, or devices. The computing device 2602 includes, but is not limited to, processing system 2610, storage system 2604, software 2606, communication interface system 2608, and user interface system 2612. Processing system 2610 is operatively coupled with storage system 2604, communication interface system 2608, and user interface system 2612.

Processing system 2610 loads and executes software 2606 from storage system 2604. Software 2606 includes and implements the neural network model 108 which is configured for optimization by the joint fine-tuning and compression process 110a. When executed by the processing system 2610, software 2606 directs processing system 2610 to operate as described herein for at least the various processes, operational scenarios, and sequences discussed in the foregoing implementations. Processing system 2610 executes the generated programs—the joint fine-tuning and compression process 110a by executing the method 200a. Computing device 2602 may optionally include additional devices, features, or functionality not discussed for purposes of brevity.

Referring to FIG. 26, processing system 2610 may comprise a micro-processor and other circuitry that retrieves and executes software 2606 from storage system 2604. Processing system 2610 may be implemented within a single processing device but may also be distributed across multiple processing devices or sub-systems that cooperate in executing program instructions. Examples of processing system 2610 include general purpose central processing units, graphical processing units, digital signal processors, application specific processors, and logic devices, as well as any other type of processing device, combinations, or variations thereof.

Storage system 2604 may comprise any computer readable storage media readable by processing system 2610 and capable of storing software 2606. Storage system 2604 may include volatile and nonvolatile, removable, and non-removable media implemented in any method or technology for storage of information, such as computer readable instructions, data structures, program modules, or other data. Examples of storage system 2604 include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 2604 may also include computer readable communication media over which at least some of the software 2606 may be communicated internally or externally. Storage system 2604 may be implemented as a single storage device but may also be implemented across multiple storage devices or sub-systems co-located or distributed relative to each other. Storage system 2604 may comprise additional elements, such as a controller, capable of communicating with processing system 2610 or possibly other systems.

Software 2606 includes the system 212 which further includes the neural network model 108 that is optimized by the joint fine-tuning and compression process 110a. Each component of the system 212 may be implemented in program instructions and among other functions may, when executed by the processing system 2610, direct processing system 2610 to operate as described with respect to the various operational scenarios, sequences, and processes illustrated herein. For example, software 2606 may include program instructions for implementing the inference and training processes described herein.

In particular, the program instructions may include various components or modules that cooperate or otherwise interact to conduct the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 2606 may include additional processes, programs, or components, such as operating system software, virtualization software, or other application software. Software 2606 may also comprise firmware or some other form of machine-readable processing instructions executable by processing system 2610.

In general, software 2606 may, when loaded into processing system 2610 and executed, transform a suitable apparatus, system, or device (of which computing device 2602 is representative) overall from a general-purpose computing system into a special-purpose computing system customized to perform inference and/or training operations performed by the system 212 in various embodiments disclosed above, in an optimized manner. Indeed, encoding software 2606 on storage system 2604 may transform the physical structure of storage system 2604. The specific transformation of the physical structure may depend on various factors in different implementations of this description. Examples of such factors may include, but are not limited to, the technology used to implement the storage media of storage system 2604 and whether the computer-storage media are characterized as primary or secondary storage, as well as other factors.

For example, if the computer readable storage media are implemented as semiconductor-based memory, software 2606 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 2608 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 2602 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The computing device 2602 shown in FIG. 26 can control a variety of exemplar systems by leveraging the principles of joint fine-tuning and compression process 110a disclosed in various embodiments described above. Exemplar systems, in embodiments, which are effectively controlled by the computing device 2602, include, but are not limited to, mobile and embedded inference 2614, factory automation 2616, EDGE/IoT 2618, AR/VR applications 2620, autonomous navigation 2622, industrial quality control 2624, medical imaging analysis 2626, and cloud computing 2628.

The system 212 including the neural network model 108 may be used for various mobile and embedded inference applications 2614, where computational, memory, and power resources are significantly constrained. By representing each neural network layer as a compressible data structure—optimized jointly across layers using a composite objective function comprising both task-specific and resource-specific components—the resulting neural network model 108 achieves a favorable balance between predictive accuracy and computational efficiency. The compressible data structure 218 may include low-rank decompositions, sparse weight matrices, quantized parameter formats, or other reduced-precision representations that substantially lower the memory footprint and number of arithmetic operations required for inference. Furthermore, because the method enables task-specific and layer-specific compression, the system can adaptively allocate resources based on the representational needs of each model component. As a result, the trained neural network model 108 can be deployed on resource-constrained platforms, such as smartphones, wearable devices, IoT modules, and embedded processors, while maintaining acceptable latency and power consumption characteristics. The technical effect of this approach is an improvement in the practical deploy ability of high-capacity neural models on edge devices, without requiring post-hoc model shrinking or manual architecture tuning.

The system 212 including the neural network model 108 may be used for various factory automation and industrial control systems 2616, where real-time inference and decision-making must be performed under strict latency, reliability, and hardware constraints. By representing each layer of the neural network model 108 as the compressible data structure 218 and optimizing these structures jointly using the composite loss function 220 that includes compression-aware penalties, the resulting neural network model 108 is capable of performing complex tasks—such as visual inspection, anomaly detection, predictive maintenance, and robotic control—on edge devices embedded within manufacturing equipment. The compressible representations reduce the model's memory footprint and computational load, enabling deployment on industrial-grade hardware such as PLCs (programmable logic controllers), MCUs (microcontroller units), or ruggedized edge computing devices. Furthermore, the ability to tailor compression strategies for different layers and target tasks allows the neural network model 108 to adapt to various factory use cases with differing performance requirements.

The system 212 including the neural network model 108 may be used for various EDGE/IoT applications 2618, where computational resources, energy availability, and network bandwidth are limited. By training the neural network model 108 with layer-wise compressible data structure 218 and the composite loss function 220 that jointly balances accuracy and resource usage, the disclosure enables deployment of compact, efficient models directly on edge nodes and IoT devices. This allows real-time inference to be performed locally-without dependence on cloud connectivity-thereby reducing latency, preserving data privacy, and improving overall system robustness in distributed environments.

The system 212 including the neural network model 108 may be used for Augmented Reality (AR) and Virtual Reality (VR) systems, which demand real-time neural inference under strict latency and power constraints.

The system 212 including the neural network model 108 may be used in autonomous systems, including autonomous vehicles, aerial drones, and robotic platforms, where real-time decision-making is critical and computational resources are often limited or power-constrained. By employing layer-wise compressible data structures that are jointly optimized for both task performance and resource efficiency, the disclosure enables deployment of neural models capable of performing perception, localization, path planning, and control tasks with reduced latency and memory usage. This allows for robust, low-power inference directly on-board autonomous agents, thereby enhancing operational safety, responsiveness, and independence from cloud infrastructure.

The system 212 including the neural network model 108 is used in industrial quality control 2624, by enabling efficient neural network inference for defect detection, visual inspection, and anomaly classification on production lines. The use of compressible data structures allows deployment of high-accuracy models on constrained hardware, ensuring real-time operation with minimal computational overhead.

The system 212 including the neural network model 108 is used in medical imaging 2626, enabling efficient neural network inference for tasks such as segmentation, classification, and anomaly detection in modalities like MRI, CT, or ultrasound. By leveraging compressible data structures, the method reduces model size and inference latency, facilitating deployment on edge medical devices while maintaining diagnostic accuracy.

The system 212 including the neural network model 108 is also used in cloud computing 2628 application, cloud computing environments, where optimizing inference efficiency at scale is critical. By using jointly optimized compressible data structures, the disclosure enables deployment of resource-efficient neural models that reduce compute load and memory usage, thereby improving throughput, lowering operational cost, and supporting scalable AI services across distributed cloud infrastructure.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching disclosure principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

1. A computer-implemented method for constructing a neural network model, the method comprising:
generating a compressible data structure for at least one weight matrix of a layer of the neural network model, the compressible data structure comprising one or more learnable parameters subject to adjustment during optimization;
determining a composite objective function associated with the neural network model, the composite objective function comprising:
a task loss component configured to evaluate predictive performance of the neural network model with respect to a target task; and
a compression loss component configured to penalize resource usage characteristics of the neural network model, the resource usage characteristics comprising one or more of: parameter dimensionality, parameter sparsity, or numerical precision;
iteratively optimizing the neural network model with respect to the composite objective function until a termination condition is met, the iterative optimization comprising performing gradient-based optimization to the one or more learnable parameters of the compressible data structure; and
outputting the optimized neural network model comprising the optimized compressible data structure.

2. The computer-implemented method of claim 1, wherein the compressible data structure comprises a low-rank decomposition of the weight matrix, represented as a product of learnable matrices of reduced dimensionality.

3. The computer-implemented method of claim 2, wherein the low-rank decomposition of the weight matrix is initialized using an activation-aware transformation, wherein the activation-aware transformation is computed based on a covariance matrix of activation data corresponding to one or more layers of the neural network model, the one or more layers including the layer of the neural network model.

4. The computer-implemented method of claim 3, wherein the activation-aware transformation is computed using a matrix formed by adding a scaled identity matrix to the covariance matrix of activation data, and raising the result to a tunable exponent, β, wherein a scaling factor λ is a damping term and β is a parameter selected from a range between 0 and 1.

5. The computer-implemented method of claim 1, wherein the compressible data structure is subject to a sparsity-inducing function comprising a differentiable masking or soft-thresholding operation applied to selected weights.

6. The computer-implemented method of claim 1, wherein the compression loss component comprises a regularization term configured to promote at least one of: weight sparsity, matrix rank reduction, and reduced numerical precision.

7. The computer-implemented method of claim 6, wherein the regularization term is progressively changed to adjust one or more of: parameter sparsity, matrix rank, and numerical precision over successive iterations.

8. The computer-implemented method of claim 1, wherein, the iterative optimization comprises: outputting at least one layer of the neural network model as a weighted combination of:
a reference output generated using a fixed pretrained weight matrix; and
a trainable output generated using the compressible structure.

9. The computer-implemented method of claim 8, wherein a weight assigned to the reference output is progressively decreased over successive iterations according to a continuous decay function, and a weight assigned to the trainable output is progressively increased over successive iterations according to the continuous decay function.

10. The computer-implemented method of claim 1, wherein the composite objective function further comprising a feature alignment loss component configured to minimize a difference between intermediate representations produced by the compressible data structure and corresponding representations produced by a non-compressed reference structure.

11. The computer-implemented method of claim 10, wherein the feature alignment loss component is weighted by a dynamic regularization coefficient that decreases during optimization, such that the influence of the feature alignment loss diminishes over time.

12. The computer-implemented method of claim 1, wherein the neural network model comprises a plurality of layers and each layer of the neural network model is associated with an independently parameterized compressible data structure, and the iterative optimization of the neural network is performed jointly across compressible data structures of the plurality of layers.

13. The computer-implemented method of claim 1, further comprising deploying the neural network model comprising the optimized compressible data structure to perform inference on input data associated with a target task.

14. The computer-implemented method of claim 13, wherein the compressible data structure is adapted specifically for the target task, such that optimization performed for a first target task produces a first compressible data structure, and optimization performed for a second target task produces a second, compressible data structure.

15. The computer-implemented method of claim 14, wherein a difference between the first compressible data structure and the second compressible data structure comprises one or more of: matrix dimensionality, sparsity pattern, initialization parameters, or learned values of trainable parameters.

16. The computer-implemented method of claim 1, wherein the resource usage characteristics penalized by the compression loss component comprise an estimated number of floating point operations (FLOPs) required for inference by the neural network model.

17. The computer-implemented method of claim 1, wherein the gradient-based optimization is implemented using a stochastic gradient descent process or a first-order optimization process.

18. The computer-implemented method of claim 1, wherein the neural network model comprises a transformer-based architecture including one or a combination of a language model, a vision transformer, a multi-modal encoder, or a diffusion model.

19. A system for constructing a neural network model configured for reduced computational resource usage, the system comprising: one or more processors; and memory storing instructions that, when executed by the one or more processors, cause the system to:
generate a compressible data structure for at least one weight matrix of a layer of the neural network model, the compressible data structure comprising one or more learnable parameters subject to adjustment during optimization;
determine a composite objective function associated with the neural network model, the composite objective function comprising:
a task loss component configured to evaluate predictive performance of the neural network model with respect to a target task; and
a compression loss component configured to penalize resource usage characteristics of the neural network model, the resource usage characteristics comprising one or more of: parameter dimensionality, parameter sparsity, or numerical precision;
iteratively optimize the neural network model with respect to the composite objective function until a termination condition is met, the iterative optimization comprising performing gradient-based optimization to the one or more learnable parameters of the compressible data structure; and
output the optimized neural network model comprising the optimized compressible data structure.

20. The system of claim 19, wherein for the iterative optimization, the system is caused to:
output at least one layer of the neural network model as a weighted combination of:
a reference output generated using a fixed pretrained weight matrix; and
a trainable output generated using the compressible structure.
